(19) United States
(12) Patent Application Publication
(10) Pub. No.: US 2006/0074788 A1
(43) Pub. Date: Apr. 6, 2006

(54) PROVIDING GOAL-BASED FINANCIAL PLANNING VIA COMPUTER

(75) Inventors: William J. Grizack, Winston-Salem, NC (US); Charles Bryan Link, Winston-Salem, NC (US); Brady McKee Mink JR., Kernersville, NC (US); Joseph Dewey Stone III, Fayetteville, NC (US)

Correspondence Address: TILLMAN WRIGHT, PLLC, PO BOX 471581, CHARLOTTE, NC, 28247, US

(73) Assignee: SIMPLIFI, LLC, Winston-Salem, NC (US)

(21) Appl. No.: 11/163,301

(22) Filed: Oct. 13, 2005

Related U.S. Application Data
(63) Continuation-in-part of application No. 11/161,455, filed on Aug. 3, 2005.
(60) Provisional application No. 60/598,721, filed on Aug. 3, 2004.

(51) Int. Cl. G06Q 40/00

(52) U.S. Cl. 705/35

(57) ABSTRACT

Interactively providing financial advice to an individual via a computer system includes: (a) receiving current information of the advisee, the current information including (i) data indicative of a current financial situation of the advisee including assets of the advisee, and (ii) data indicative of a currently intended future life event of the advisee; (b) determining a future financial obligation of the advisee that is representative of the intended future life event of the advisee; (c) determining a rate of return on investment that is required in order for the advisee to meet the future financial obligation based on the advisee's current financial situation; and (d) providing to the advisee a recommended asset allocation and an indication of the probability that the future financial obligation will be met based on the advisee's current financial situation and the recommended asset allocation. Assistance may be provided through a virtual human advisor.

### RELATED APPLICATIONS

The present application is a continuation-in-part of U.S. nonprovisional patent application Ser. No. 11/161,455, filed on Aug. 3, 2005, which is a nonprovisional patent application of U.S. provisional patent application Ser. No. 60/598,721 filed Aug. 3, 2004. Priority is claimed under 35 U.S.C. 119(e) and 120 to each of these filing dates, and each of these patent applications is hereby incorporated by reference herein.

### COPYRIGHT STATEMENT

All of the material in this patent document, including the computer program listing, is subject to copyright protection under the copyright laws of the United States and other countries. The copyright owner has no objection to the facsimile reproduction by anyone of the patent document or the patent disclosure, as it appears in official governmental records but, otherwise, all other copyright rights whatsoever are reserved.

### COMPUTER PROGRAM LISTING

Submitted concurrently herewith via the USPTO's electronic filing system, and incorporated herein by reference, is a computer program listing representing computer instructions, routines, and/or other contents of computer programs used in a commercial embodiment of the invention. The computer program listing specifically includes sixty-six electronic file(s). Of these files, sixty-five files include the aspx file extension and are Mircorosoft ASP.net files generally written using the C# programming language. The other file is a text file containing flash source code. A table setting forth the name and size of each file included in the computer program listing is included in FIG. 36. The target hardware for this implementation includes networked computers and/or file servers and client computers preferably running a Windows operating system.

### FIELD OF INVENTION

The field of the present invention generally relates to methods and systems of providing to consumers interactive financial planning information through the use of automated or computerized systems, and especially such systems that utilize personal computers of the consumers.

### BACKGROUND OF INVENTION

Financially prudent individuals often develop a comprehensive financial plan that will aid them in achieving their financial goals. More recently, some individuals have increasingly relied upon computer-based systems that organize their financial assets and liabilities and further provide them with a summary of their financial health. However, these systems tend to focus on the administrative aspects of financial planning without effectively enabling individuals to make reasoned choices about their financial futures. To do so, individuals need a financial tool that approaches modeling from an executive decision-making perspective.

Traditionally, some individual investors have relied on investment advisors to manage their investment portfolios. However, investment advisors can be expensive, and investors who traditionally use personal fund managers or advisors often have portfolios in excess of one million dollars. Some investors may have difficulty accessing such investment advisors, due to factors such as minimum balances or investment funds requirements, geographic distance limitations, and conventional structuring or practices of financial institutions.

An advisor spends time ascertaining a client's goals, market attitude, preferences and risk tolerance. The advisor then accumulates all the financial information regarding the individual and models the individual's investment portfolio. A thorough investigation can be required to provide good advice, taking the client's tax liability, lifestyle, expenses and unforeseen events into consideration as well as the individual's financial goals. This process can be expensive and, thus, priced out of the reach of the majority of investors.

Further, with the movement of retirement plans offered by employers away from defined benefit plans toward defined contribution plans, an increasing number of middle-income individuals need investment advice to manage their retirement accounts and plan for significant life events, such as raising and educating children, purchasing a home, and managing consumer debt. The number of retirement plans available (e.g., IRA, traditional IRA, 401 k) and educational plans available (e.g., Educational IRA and 529 Plans) also increase the complexity of the financial needs of middle-income individuals and thereby the need for financial planning advice. Other factors contributing to the complexity of the financial status of middle-income individuals are the low savings rates of middle-income individuals and the high debt-to-income ratios.

Evidence of the need and demand for financial planning services and advice can be seen in the increasing number of books, magazines, and television programs offering financial advice to middle-income individuals. Most of this information is general in nature and is not interactive.

Financial service providers, such as banks and brokerage firms, also have begun to offer limited services targeted towards middle-income individuals. However, middle-income individuals may need a greater amount of services in proportion to their assets relative to the amount of services wealthy individuals may need in proportion to their assets. For example, purchases such as an automobile or a house, and payments thereon, may represent ten percent to thirty percent of a middle-income individual's income, and appropriately structuring the debt and determining what level of debt is advisable can be critically important and have long-term impact on that individual's financial security.

Software packages and online software packages also are available. In these types of packages, an individual completes an in-depth survey of his financial status and a single investment plan is output. Often these financial planning software packages focus on planning for a single life event, such as retirement. Often, little, if any, explanation is given when data is input and the plan is output. Furthermore, it is believed that individuals using the current software packages commercially available often never even complete the initial entry of personal financial data. This may result from an absence of any explanation for the reason for collecting certain of the information when such software packages are used.

In the end, most middle-income individuals have complex investment and financial planning goals that they wish to achieve, and they usually need more than a raw table or a list of numbers to help them determine the best financial strategy under their individual circumstances.

### SUMMARY OF THE PRESENT INVENTION

Briefly described, the present invention relates to interactive methods and systems for providing financial advice to an individual via a computer system.

The method preferably includes: receiving current information of an individual, the current information including (i) data indicative of a current financial situation of the individual, including the individual's assets, and (ii) data indicative of a currently intended future life event of the individual; and determining a future financial obligation of the individual that is representative of the intended future life event of the individual. The method further includes determining a rate of return on investment that is required in order for the individual to meet the future financial obligation based on the individual's current financial situation; and then providing to the individual a recommended asset allocation and an indication of the probability that the future financial obligation will be met based on the individual's current financial situation and the recommended asset allocation.

As used herein, “advisee” refers to an individual receiving financial advice in accordance with one or more embodiments of the present invention. Furthermore, “individual” may refer to one or more persons whom, for purposes of financial planning, are treated as a single entity. For instance, a married couple may be treated as a single entity for purposes of financial planning.

In a feature of the present invention, the interactive financial planning method and system closely replicates an individual's experience of having a conversation with a financial planner.

In another feature of the present invention, the system and method provide graphical user interfaces (GUIs) that simplify the display of financial plan information and enable ready modification by the advisee of underlying assumptions of the plan, such as dates of financial life events. The system and method further provide GUIs for understanding effects of a currently intended life event on an advisee's financial planning as well the tolerance for such life event in the advisee's recommended financial plan.

The GUIs of the invention also preferably provide an interface that is more attractive to individual consumers, as compared to other commercially available software packages that tend to be targeted towards investment advisors, banks, and other professionals. Indeed, one or more preferred embodiments of the present invention are intended to address the need to automate many of the functions traditionally performed by live advisors so that at least middle-income individuals have access to the financial planning and advice conventionally provided to wealthier individuals.

### BRIEF DESCRIPTION OF DRAWINGS

One or more preferred embodiments of the present invention now will be described in detail with reference to the accompanying drawings, wherein the same elements are referred to with the same reference numerals, and wherein:

FIG. 1 illustrates a preferred embodiment of a computer system architecture of the present invention.

FIG. 2 is a block diagram of the interactive, automated coaching system of FIG. 1.

FIG. 3 is a block diagram of a representative hardware environment of the user terminal of FIG. 1 in accordance with a preferred embodiment of the present invention.

FIG. 4 is a block diagram of a representative hardware environment of the financial planning system of FIG. 1 in accordance with a preferred embodiment of the present invention.

FIG. 5 is an illustration of an interactive financial planning advisor interface for receiving information regarding demographic information in accordance with a preferred embodiment of the present invention.

FIG. 6 is a block diagram of an exemplary data collection flow within a user demographic information module in accordance with a preferred embodiment of the present invention.

FIG. 7 is an illustration of an interactive financial planning advisor interface for receiving information regarding current financial situations in accordance with a preferred embodiment of the present invention.

FIG. 8 is a block diagram of an exemplary data collection flow within a financial data collection module in accordance with a preferred embodiment of the present invention.

FIG. 9 is an illustration of an interactive financial planning advisor interface for receiving information regarding currently intended future life events and for representing the probability of achieving those life events already specified in accordance with a preferred embodiment of the present invention.

FIG. 9a is another illustration of an interactive financial planning advisor interface for receiving information regarding currently intended future life events and for representing the probability of achieving those life events already specified in accordance with a preferred embodiment of the present invention.

FIG. 10 is a block diagram of an exemplary data collection flow within a directed goal selection module in accordance with a preferred embodiment of the present invention.

FIG. 11 is an illustration of an interactive financial planning advisor interface for displaying a probability of meeting current goals and for tailoring factors influencing such probability in accordance with a preferred embodiment of the present invention.

FIG. 12 is a block diagram of an exemplary data collection flow within a financial plan customization module in accordance with a preferred embodiment of the present invention.

FIG. 13 is an illustration of an interactive financial planning advisor interface displaying a financial situation comprising a result set in accordance with a preferred embodiment of the present invention.

FIG. 14 is an illustration of an interactive financial planning advisor interface displaying a financial situation comprising an indication of an effect of achieving a user-specified financial goal on a probability of meeting a plurality of user-specified financial goals and on a value of net assets in accordance with a preferred embodiment of the present invention.

FIG. 15 is an illustration of an interactive financial planning advisor interface displaying a financial situation comprising an indication of an effect of achieving another further user-specified financial goal on a probability of meeting a plurality of user-specified financial goals and on a value of net assets in accordance with a preferred embodiment of the present invention.

FIG. 16 is an illustration of an interactive financial planning advisor interface displaying a financial situation comprising an indication of an effect of achieving yet another user-specified financial goal on a probability of meeting a plurality of user-specified financial goals and on a value of net assets in accordance with a preferred embodiment of the present invention.

FIG. 17 is an illustration of an interactive financial planning advisor interface displaying a financial situation comprising an indication of an effect of achieving a further user-specified financial goal on a probability of meeting a plurality of user-specified financial goals and on a value of net assets in accordance with a preferred embodiment of the present invention.

FIG. 18 is an illustration of an interactive financial planning advisor interface displaying a financial situation comprising a plurality of asset allocations associated with different levels of risk, potentials for growth, and time periods in the future in accordance with a preferred embodiment of the present invention.

FIG. 19 is an illustration of an interactive financial planning advisor interface displaying a financial situation comprising another plurality of asset allocations associated with different levels of risk, potentials for growth, and time periods in the future in accordance with a preferred embodiment of the present invention.

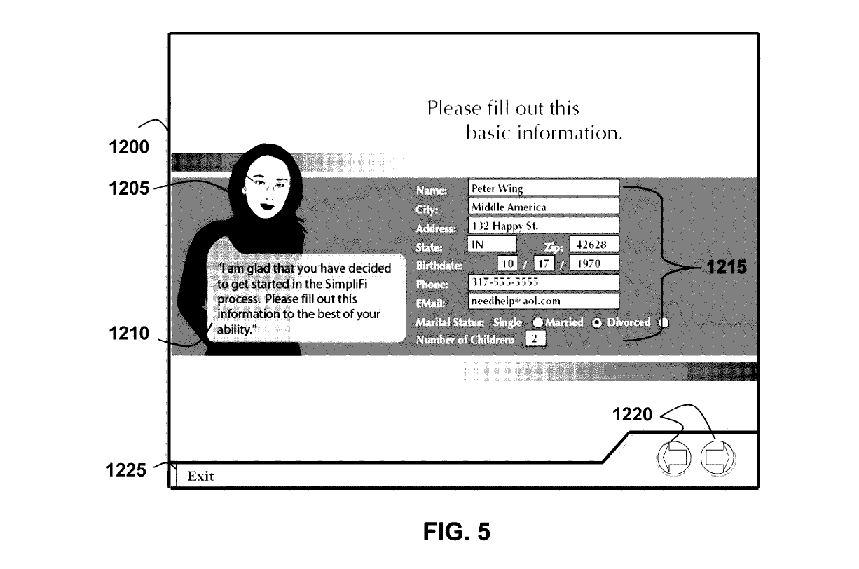

Similar to FIG. 5, FIG. 20 illustrates an alternative interactive financial planning advisor interface for receiving information regarding demographic information in accordance with a preferred embodiment of the present invention.

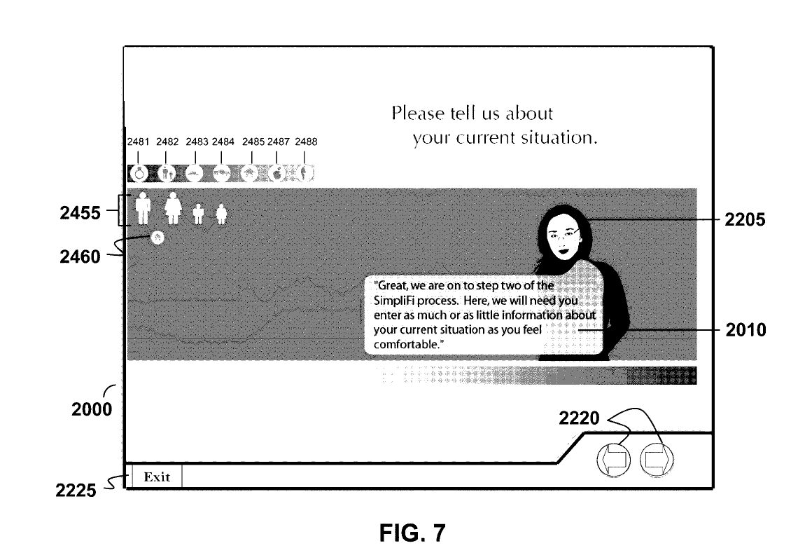

Similar to FIG. 7, FIGS. 21-23 collectively illustrate alternative interactive financial planning advisor interfaces for receiving information regarding current financial situations in accordance with a preferred embodiment of the present invention, wherein FIG. 21 illustrates an interactive financial planning advisor interface for receiving information regarding owned assets, FIG. 22 illustrates an interactive financial planning advisor interface for receiving information regarding investments, and FIG. 23 illustrates an interactive financial planning advisor interface for receiving information regarding debts.

FIG. 24 illustrates an interactive financial planning advisor interface for receiving specific information regarding a primary residence that is owned, which interface is presented following the interface of FIG. 21 when the “Home” hyperlink is selected.

FIG. 25 illustrates an interactive financial planning advisor interface for receiving specific information regarding a retirement account, which interface is presented following the interface of FIG. 22 when the “401 K” hyperlink is selected.

FIG. 26 illustrates an interactive financial planning advisor interface for receiving specific information regarding a student loan, which interface is presented following the interface of FIG. 23 when the “Student Loans” hyperlink is selected.

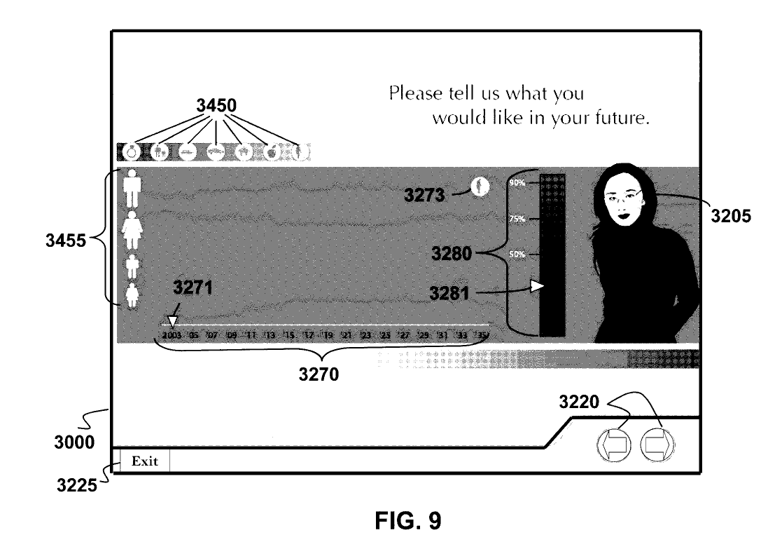

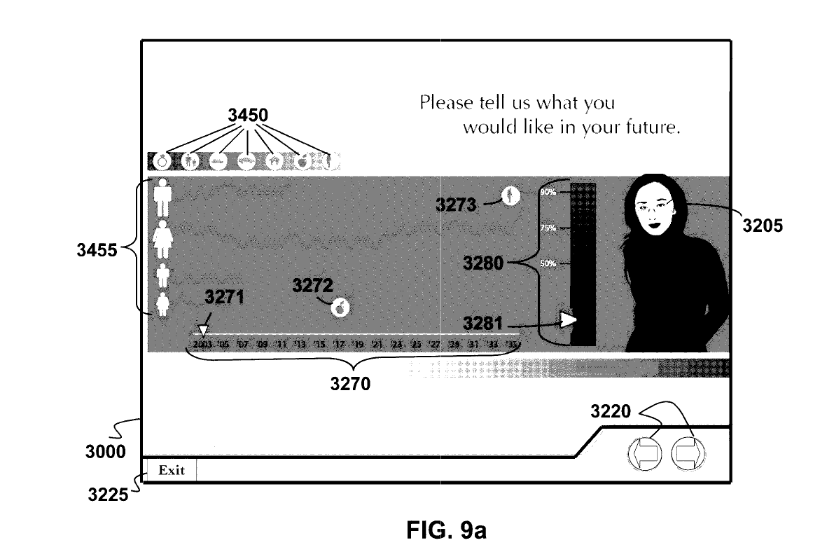

Similar to FIGS. 9 and 9a, FIG. 27 illustrates an alternative interactive financial planning advisor interface for receiving information regarding currently intended future life events in accordance with a preferred embodiment of the present invention.

FIG. 28 illustrates an interactive financial planning advisor interface for receiving specific information regarding a currently intended future purchase of a primary residence, which interface is presented following the interface of FIG. 27 when the hyperlinked icon for a house is selected.

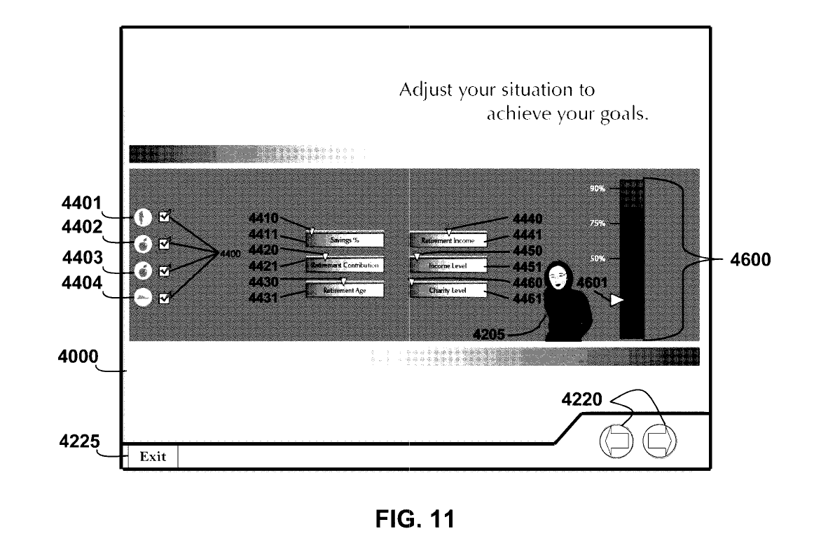

Similar to FIG. 11, FIG. 29 illustrates an alternative interactive financial planning advisor interface for displaying a probability of meeting current goals and for tailoring factors influencing such probability in accordance with a preferred embodiment of the present invention.

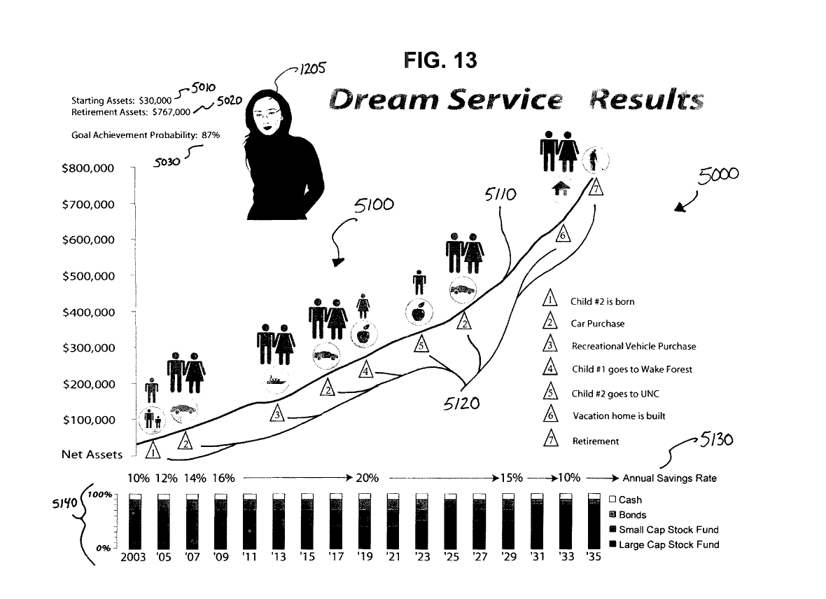

Similar to FIG. 13, FIG. 30 illustrates an alternative interactive financial planning advisor interface displaying a financial situation comprising a result set—or “Goal Blueprint™” results—in accordance with a preferred embodiment of the present invention, wherein the specified currently intended future financial goals are represented, wherein a recommended asset reallocation is represented, and wherein a probability of meeting the specified currently intended future financial goals is represented.

FIG. 31 illustrates a “Goal Achievement Probability Graph” that visually represents statistical output of a financial model simulation used to generate the probability represented in the interface of FIG. 30.

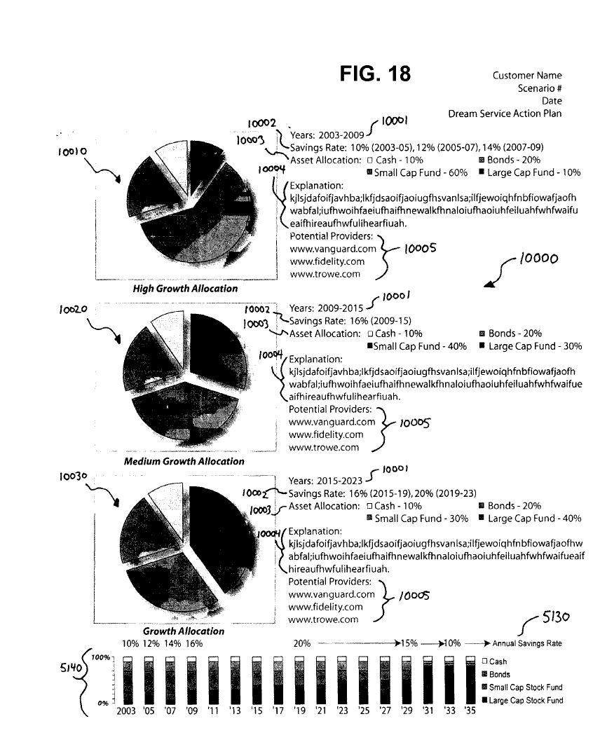

Similar to FIG. 18, FIG. 32 illustrates an alternative interactive financial planning advisor interface displaying a financial situation comprising a plurality of current asset allocations among different investment types (e.g., large cap, small cap, bonds, and cash) and recommended reallocations among the different investment types in accordance with a preferred embodiment of the present invention.

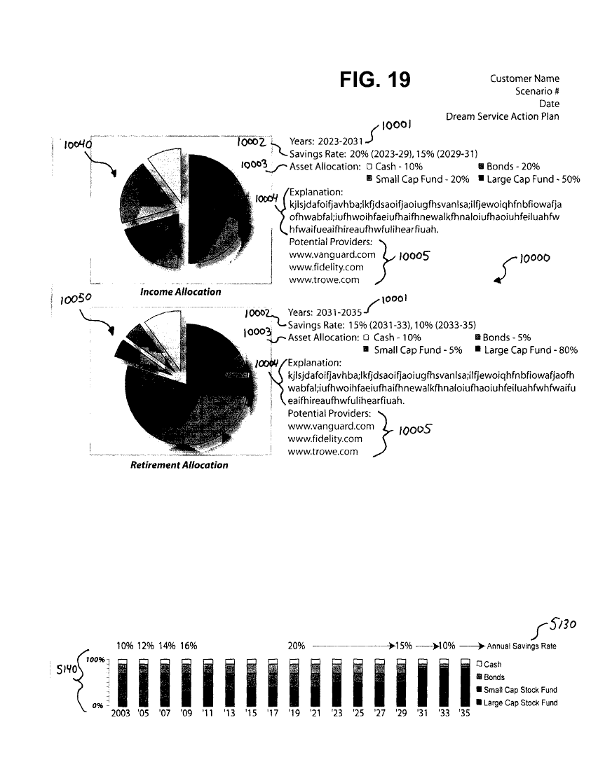

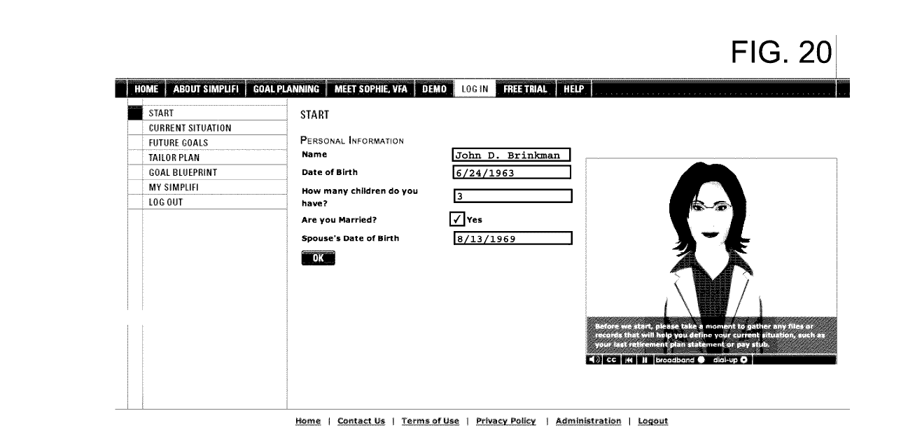

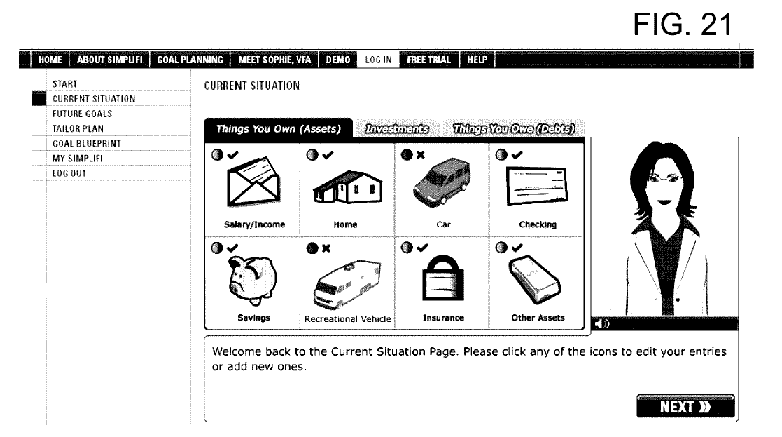

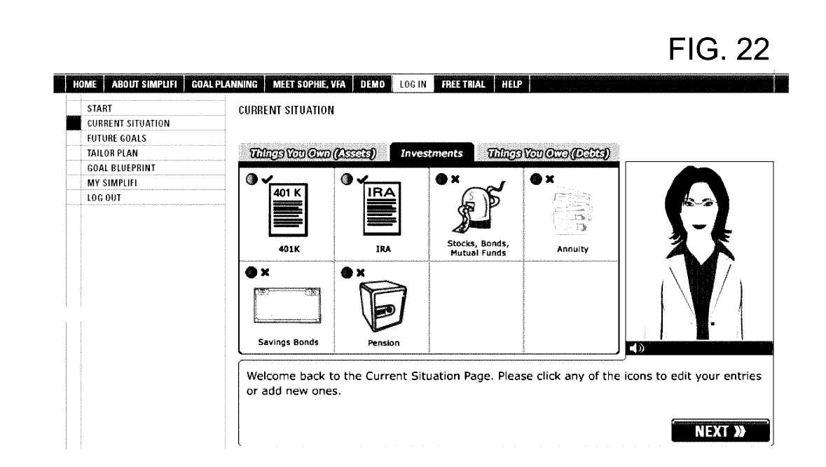

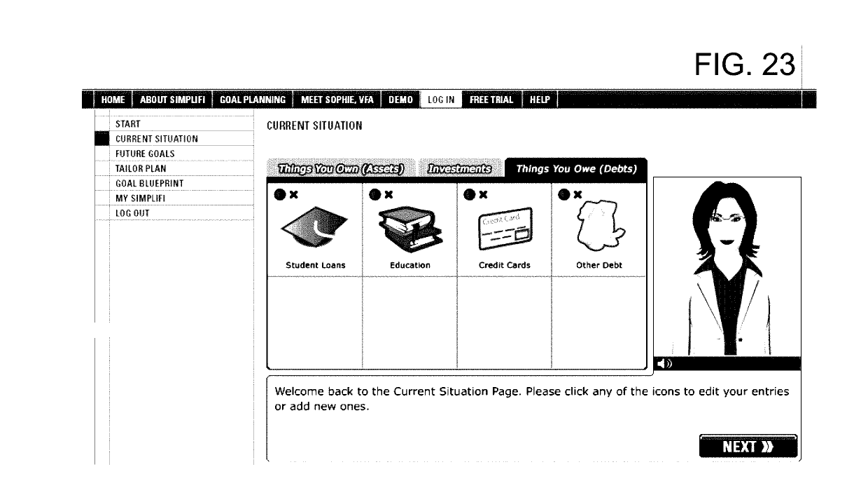

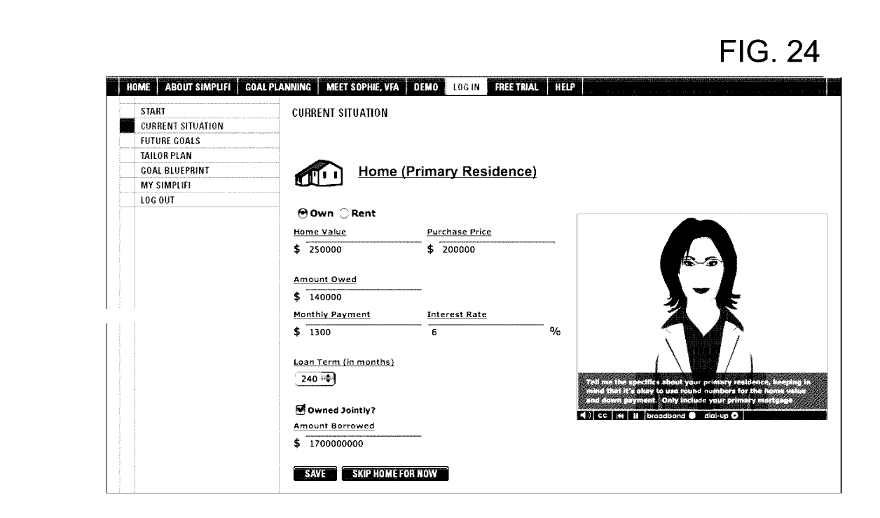

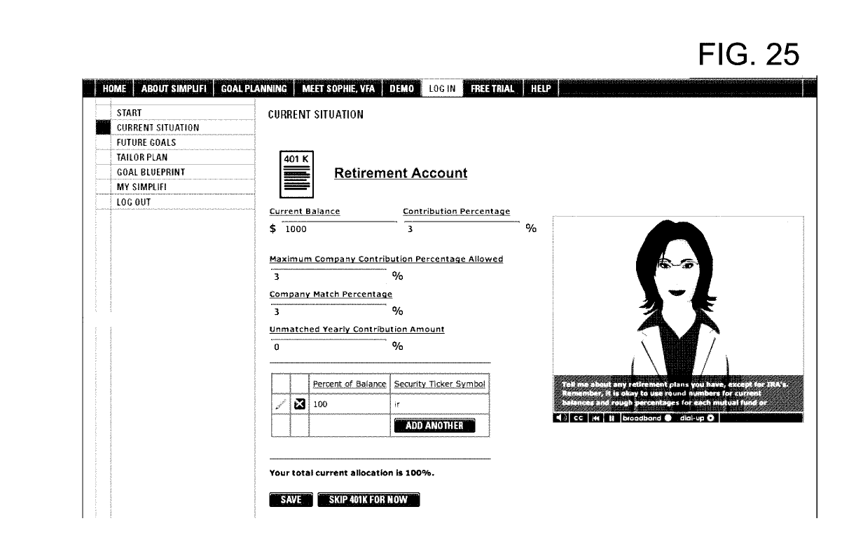

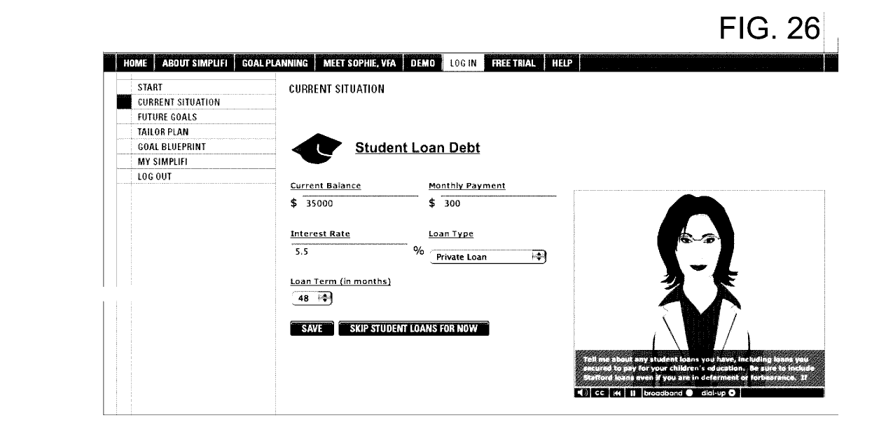

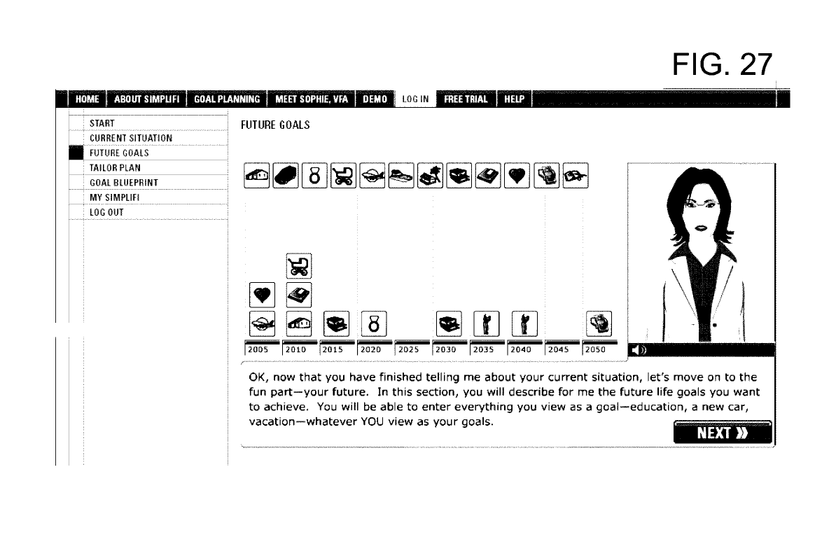

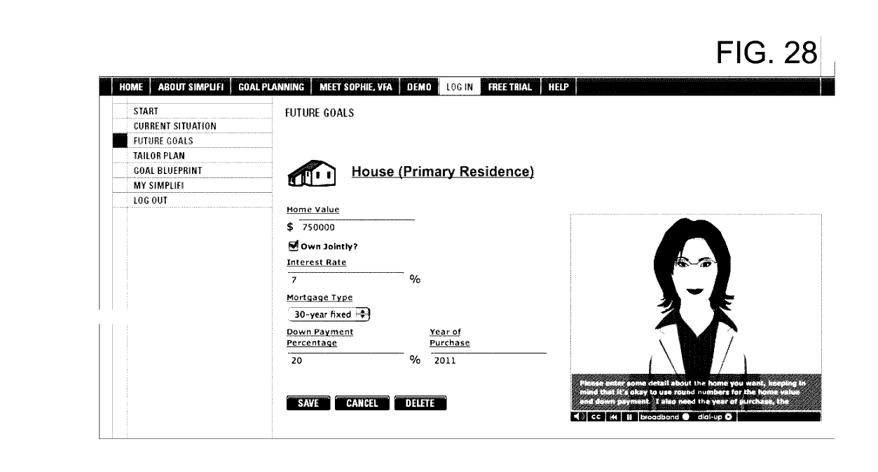

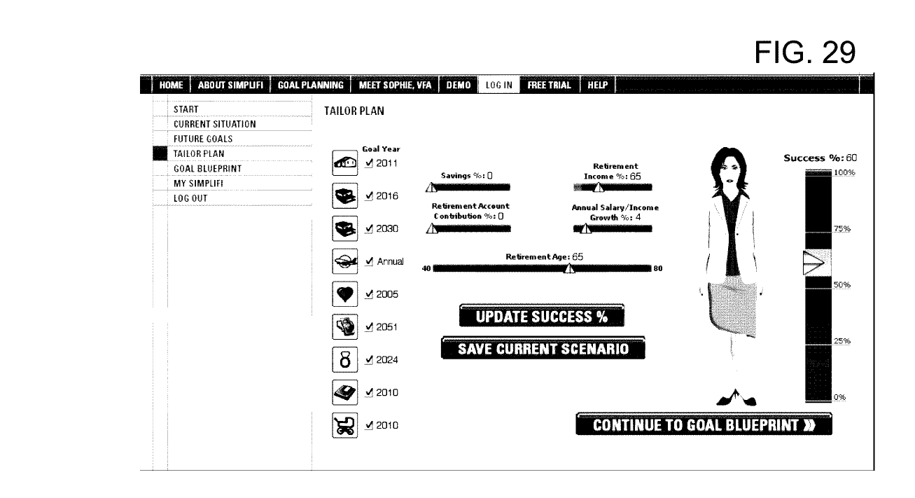

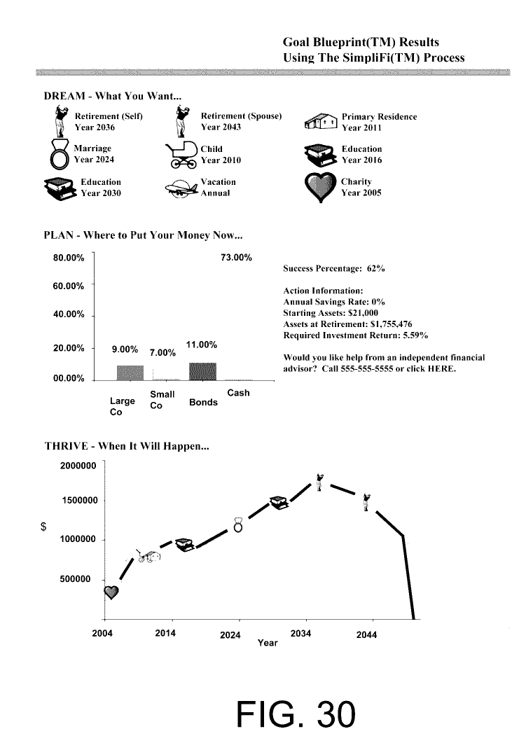

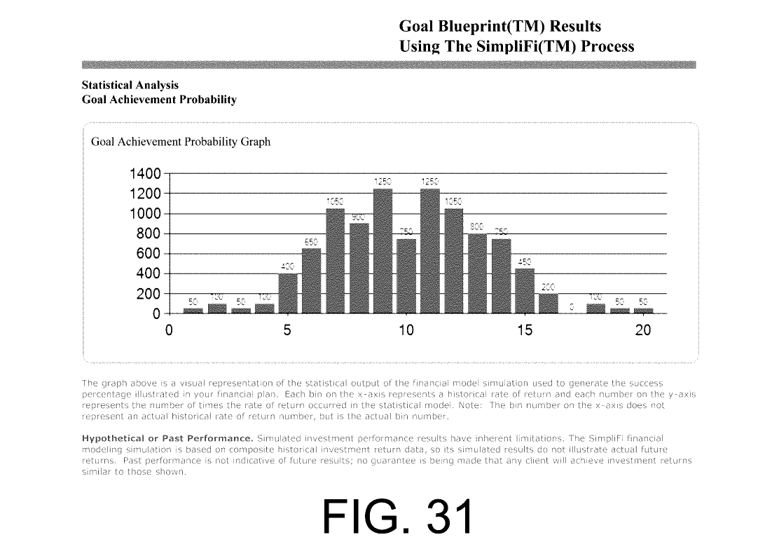

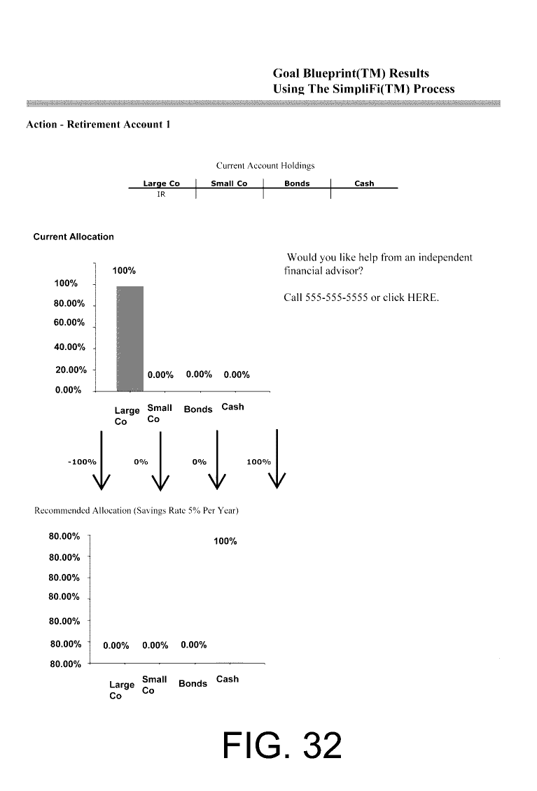

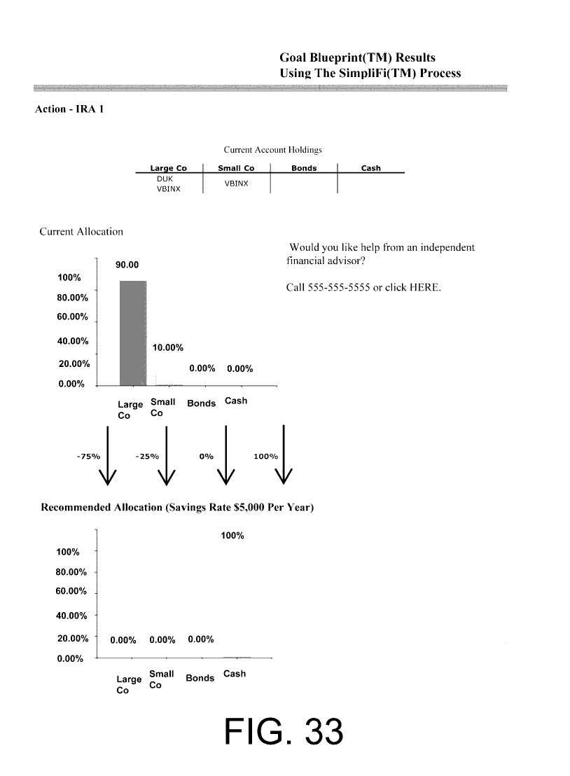

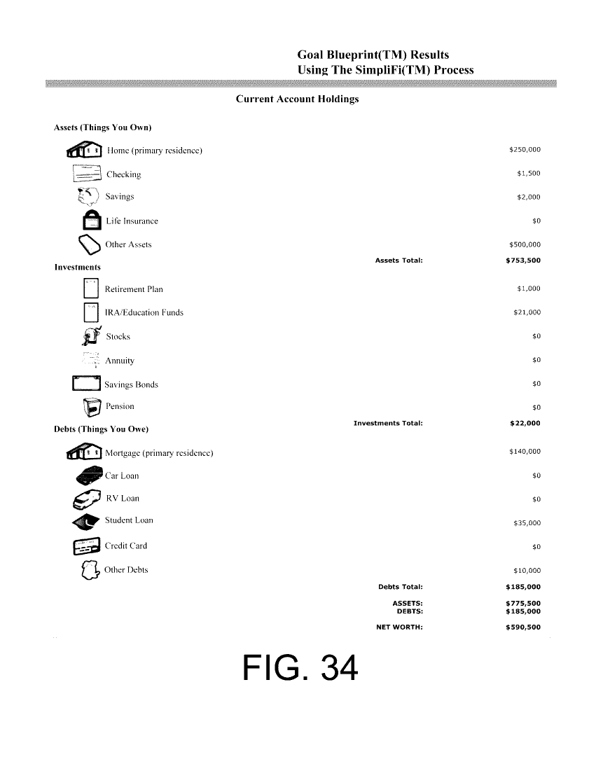

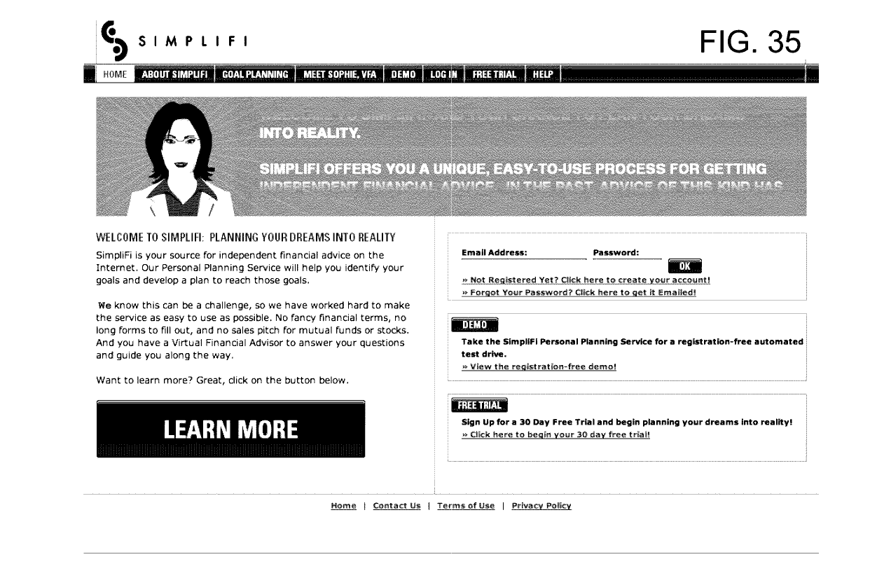

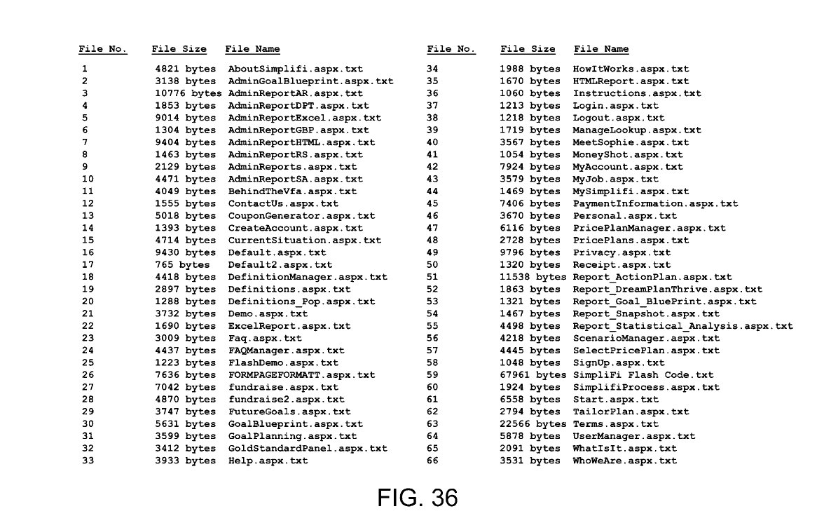

Similar to FIG. 19, FIG. 33 illustrates another alternative interactive financial planning advisor interface displaying a financial situation comprising a plurality of current asset allocations among different investment types (e.g., large cap, small cap, bonds, and cash) and recommended reallocations among the different investment types in accordance with a preferred embodiment of the present invention.

FIG. 34 illustrates a personal financial snapshot associated with the “Goal Blueprint™” results in accordance with a preferred embodiment of the present invention.

FIG. 35 illustrates an exemplary home page on the Internet where preferred financial services are offered in accordance with a preferred embodiment of the present invention.

FIG. 36 illustrates a table of computer files represented in the computer program listing submitted electronically with the application filing, which has been incorporated herein by reference and forms a part of this specification.

### DETAILED DESCRIPTION

As a preliminary matter, it will readily be understood by one having ordinary skill in the relevant art (“Ordinary Artisan”) that the present invention has broad utility and application. Furthermore, any embodiment discussed and identified as being “preferred” is considered to be part of a best mode contemplated for carrying out the present invention. Other embodiments also may be discussed for additional illustrative purposes in providing a full and enabling disclosure of the present invention. Moreover, many embodiments, such as adaptations, variations, modifications, and equivalent arrangements, will be implicitly disclosed by the embodiments described herein and fall within the scope of the present invention.

Accordingly, while the present invention is described herein in detail in relation to one or more embodiments, it is to be understood that this disclosure is illustrative and exemplary of the present invention, and is made merely for the purposes of providing a full and enabling disclosure of the present invention. The detailed disclosure herein of one or more embodiments is not intended, nor is to be construed, to limit the scope of patent protection afforded the present invention, which scope is to be defined by the claims and the equivalents thereof. It is not intended that the scope of patent protection afforded the present invention be defined by reading into any claim a limitation found herein that does not explicitly appear in the claim itself.

Thus, for example, any sequence(s) and/or temporal order of steps of various processes or methods that are described herein are illustrative and not restrictive. Accordingly, it should be understood that, although steps of various processes or methods may be shown and described as being in a sequence or temporal order, the steps of any such processes or methods are not limited to being carried out in any particular sequence or order, absent an indication otherwise. Indeed, the steps in such processes or methods generally may be carried out in various different sequences and orders while still falling within the scope of the present invention. Accordingly, it is intended that the scope of patent protection afforded the present invention is to be defined by the appended claims rather than the description set forth herein.

Additionally, it is important to note that each term used herein refers to that which the Ordinary Artisan would understand such term to mean based on the contextual use of such term herein. To the extent that the meaning of a term used herein—as understood by the Ordinary Artisan based on the contextual use of such term-differs in any way from any particular dictionary definition of such term, it is intended that the meaning of the term as understood by the Ordinary Artisan should prevail.

Furthermore, it is important to note that, as used herein, “a” and “an” each generally denotes “at least one,” but does not exclude a plurality unless the contextual use dictates otherwise. Thus, reference to “a picnic basket having an apple” describes “a picnic basket having at least one apple” as well as “a picnic basket having apples.” In contrast, reference to “a picnic basket having a single apple” describes “a picnic basket having only one apple.”

When used herein to join a list of items, “or” denotes “at lease one of the items,” but does not exclude a plurality of items of the list. Thus, reference to “a picnic basket having cheese or crackers” describes “a picnic basket having cheese without crackers”, “a picnic basket having crackers without cheese”, and “a picnic basket having both cheese and crackers.” Finally, when used herein to join a list of items, “and” denotes “all of the items of the list.” Thus, reference to “a picnic basket having cheese and crackers” describes “a picnic basket having cheese, wherein the picnic basket further has crackers,” as well as describes “a picnic basket having crackers, wherein the picnic basket further has cheese.”

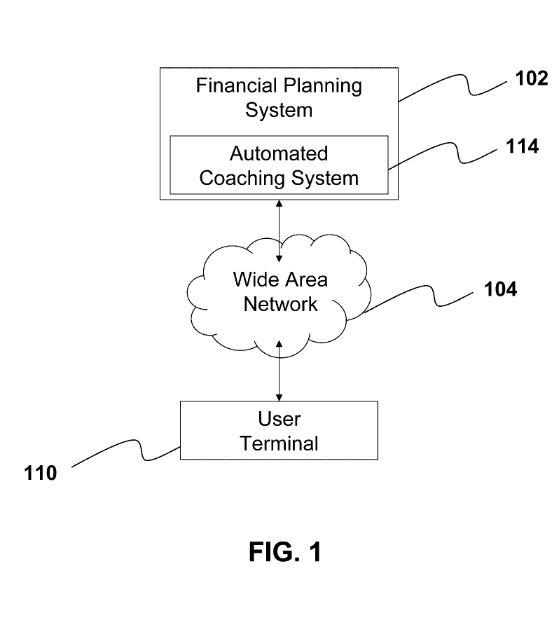

Turning now to the drawings, FIG. 1 illustrates a preferred embodiment of an interactive financial information system for providing personalized financial planning in an interactive computing environment in accordance with the present invention.

The interactive financial information system of FIG. 1 comprises an interactive financial planning system 102 connected through a wide area network 104 to a user terminal 110. The wide area network 104 preferably represents the Internet, which is based on the TCP/IP communication protocol.

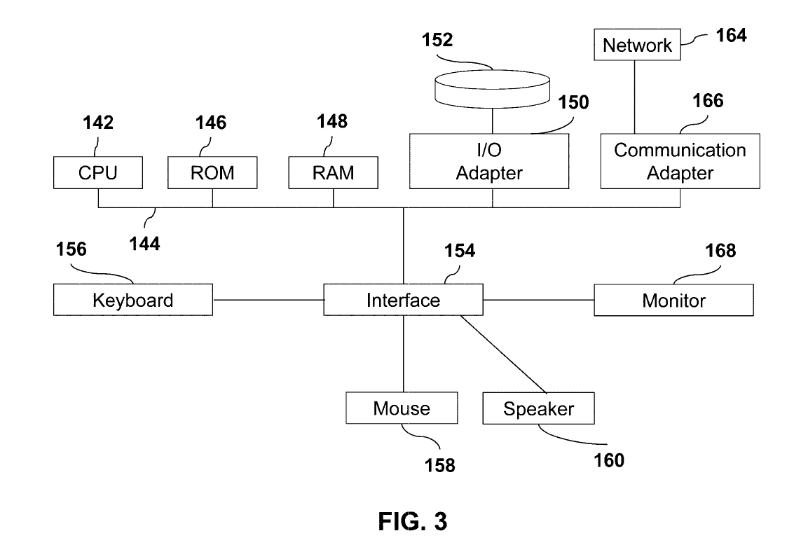

The interactive financial planning system 102 communicates with a user through the user terminal 110, which may comprise any number of devices such as a handheld wireless personal organizer, pager, cellular telephone, land telephone, laptop computer, and desktop computer. Preferably, the interaction is in accordance with a client-server type system, and the user terminal 110 preferably comprises a desktop or laptop computer described, for example, in further detail below with regard to FIG. 3. It should be noted, however, that various computing platforms could be used to access the interactive financial planning system 102 of the present invention. For example, a networked personal computer environment, a client-server system, a mainframe terminal environment, WEB TV terminal environment, and dumb terminal environments can be used to access the financial management system of present invention.

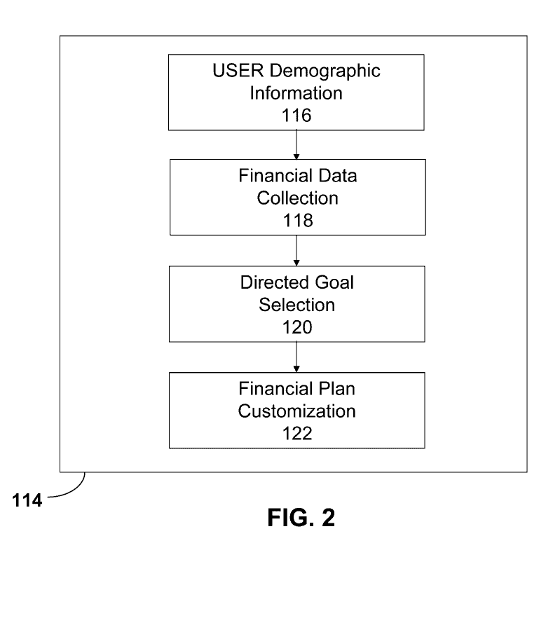

FIG. 2 is a block diagram of the interactive automated coaching system 114 (also sometimes referred to as a “virtual financial advisor,” “virtual human advisor,” and/or “VFA”). Information regarding an advisee is collected in the user information module 116 and passed to the data collection module 118 where relevant pieces of financial information are collected. The directed goal selection module 120 allows the financial goals to be defined as well as the timing and priority of the various defined financial goals. The financial plan customization module 122 allows factors and other criteria to be adjusted or tailored by the user in order to determine the most appropriate balance resulting in a desired probability for meeting the selected goals.

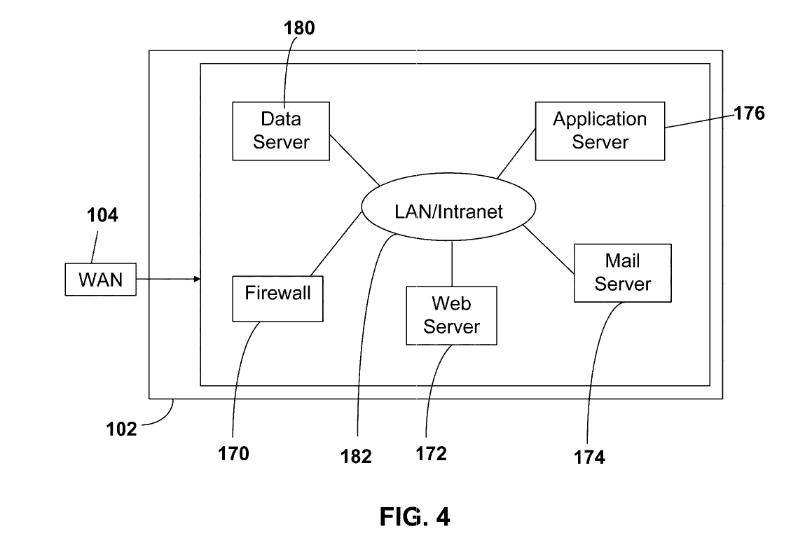

FIG. 3 is an exemplary computer system architecture of the preferred user terminal 110. This computer system architecture also preferably is used to implement the servers identified below in FIG. 4. Alternatively, other computer system architectures are suitable as well. The preferred computer system architecture of FIG. 3 comprises a central processing unit 142, such as a microprocessor; a read only memory (ROM) 146; a random access memory (RAM) 148; an input and output adapter 150; a storage device 152 such as a hard disk drive, a floppy drive, a CD-Rom drive, a DVD drive, a tape device, a removable, a jazz drive, or a ZIP drive; an interface 154 connecting a plurality of input and output devices, such as a keyboard 156, a mouse 158, a speaker 160, and a display 168; a network adapter 166 such as a dial-up modem, a Digital Subscriber Line (DSL) modem, or a cable modem, for connecting the workstation to a network 104 (e.g., the Internet); and a system bus 144 interconnecting all the components together. The computer system architecture also may include such devices as a touch screen (not shown) connected to the bus 144.

Personal computer platforms representative of the computer system architecture of FIG. 3 include IBM compatible personal computers, Apple Macintosh computers, and UNIX based workstations, and the operating system environment for practicing the present invention may include the Windows, NT, UNIX, Solaris, and Apple operating systems, or an open source operating system software such as Linux and Apache.

FIG. 4 is a block diagram of a representative hardware environment of the interactive financial planning system 102. The user may access the system through the wide area network 104 and through a firewall server 170. A web server 172 can provide the user with a personalized website providing an interactive interface between the user and the interactive financial planning system 102. The interactive financial planning system 102 may further comprise a mail server 174, an application server 176, and a data server 180 all connected to the local area network 182. The local area network (LAN) 182 further may comprise any wide area intranet system.

Security is important in any financial system. In an embodiment, a firewall server 170 may control access to the interactive financial planning system 102. The purpose of a firewall server is to prevent access to the system by unauthorized users. Firewall servers are available through a variety of vendors and have become a standard feature of any secure system used as the primary defense against intruders and hackers.

The web server 172 provides a personalized interactive web page though which the user interfaces with the financial systems. Web pages can be created using the Hyper Text Markup Language (HTML) and scripting languages such as Java Script or Pearl, as well as Java applets. Creation of customized web page using any of the above programming languages is well within the scope of one skilled in the arts.

The mail server 174 handles electronic mail communication between the user and the interactive financial planning system 102. The mail server 174 may operate using any standard protocol such as Simple Mail Transfer Protocol (SMTP), and its implementation is within the scope of the knowledge of one skilled in the art.

Various modules including decision trees and paths (described below) of the interactive financial planning system 102 preferably reside on the application server 176. The modules may be implemented in a wide variety of suitable programming languages, such as object oriented programming languages such as C sharp, C++, or java, and may be based on any suitable operating system platform such as UNIX, Apple OS, or Windows. Alternatively, all or some of the modeling tools, and all or some of the automated coaching engines, may reside on the application server 176.

The data server 180 stores input data from the user terminal 110 for accessing by the application server 176. The data server 180 may physically reside on many servers and may comprise outside databases from which the financial advising system 102 can draw information from third party sources, such as: actuarial data; historical price data on securities from sources such as Morningstar; financial information of the advisee, such as banking and portfolio information maintained in other financial institution systems; market information, such as the days closing numbers for various market indices as well as individual stock securities pricing information; and the goals and characteristics of mutual funds. Rules and algorithms for path selection modules 350, 450, 550 (described below) and Monte Carlo simulation modules 460, 560, and 660 (described below) also may reside on the data server 180. Furthermore, it should be appreciated by the Ordinary Artisan that, while the servers are separately illustrated in FIG. 4, such illustration is a preferred logical representation, the actual physical systems may be distributed over many physical locations or located on a single machine.

Turning now to FIGS. 5-12, a user's interaction with the financial planning system for obtaining goal-based financial planning advice is described in detail. In describing this interaction, the user preferably comprises the individual receiving the financial advice, i.e., the user preferably is the advisee.

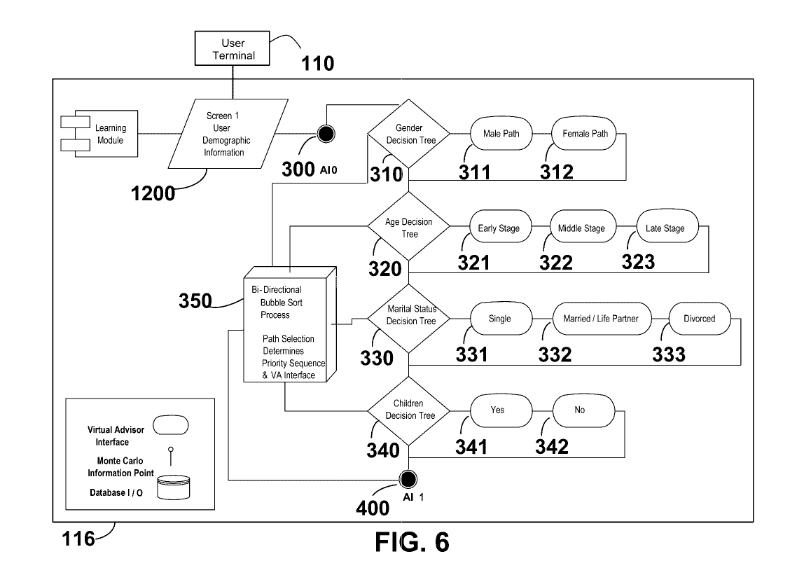

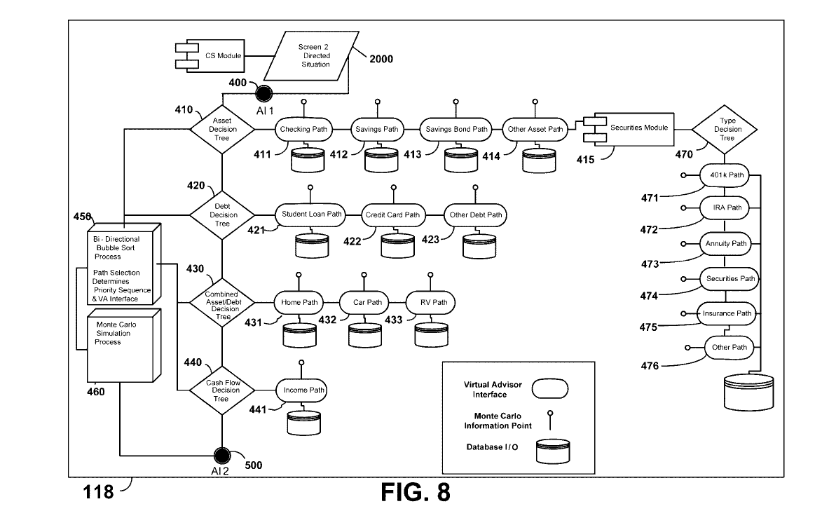

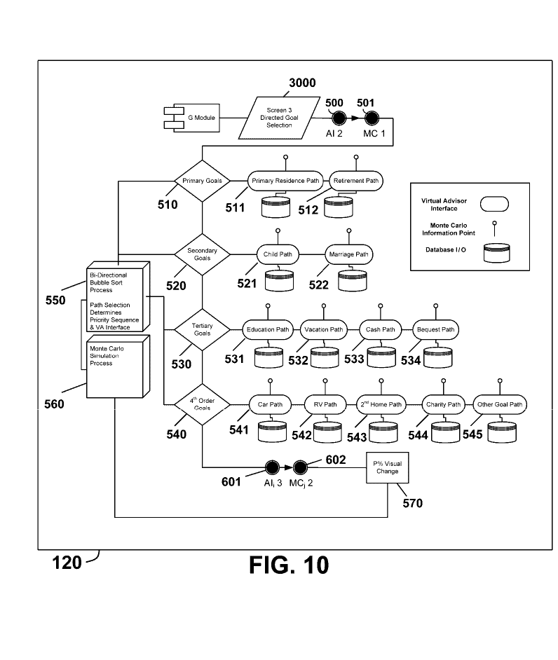

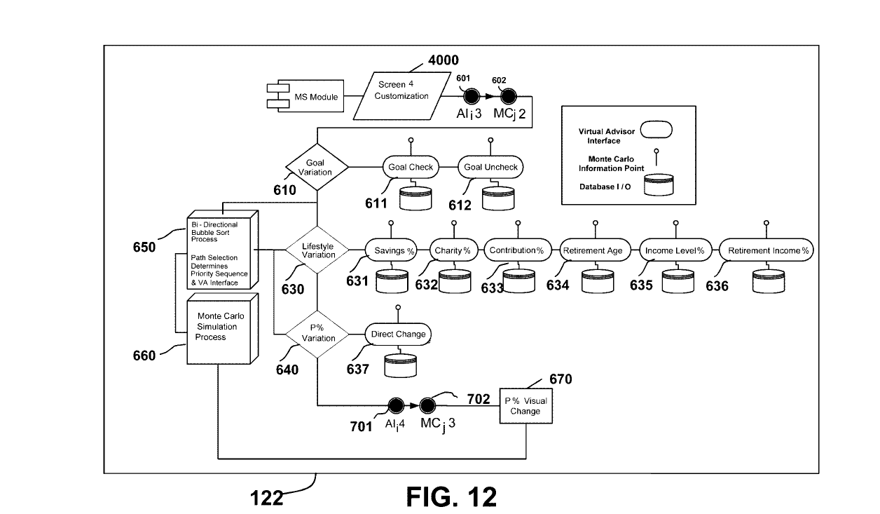

A graphical user interface (GUI) and data flow associated therewith are set forth in each of FIGS. 5 and 6, FIGS. 7 and 8, FIGS. 9 and 10, and FIGS. 11 and 12. In particular, FIGS. 5 and 6 describe a GUI and data flow associated with the initial interaction of the user with “Sophie,” a virtual human advisor. FIGS. 7 and 8 describe a GUI and data flow associated with the collection of information regarding a user's current financial situation. FIGS. 9 and 10 describe a GUI and data flow associated with the collection of information regarding a user's currently intended future life events. FIGS. 11 and 12 describe a GUI and data flow associated with adjusting various factors to reach a user's financial goals represented by the user's currently intended future life events.

Receiving Demographic and Other User Information

Referring to FIG. 5, GUI 1200 is shown that embodies various concepts and methods set forth for financial planning and collection of user demographic information in a user demographic information module 116. GUI 1200 embodies various concepts and methods set forth for financial planning in collecting demographic and other user information in user demographic information module 118.

As shown, the GUI 1200 comprises a “virtual advisor” (sometimes labeled VA in the drawings) or “virtual human advisor” 1205 with an associated dialogue box 1210 containing text relevant to the process of collecting demographic information and otherwise interacting with the user. The GUI 1200 shown further comprises fields 1215 configured specifically to receive various, preferred pieces of user demographic information including the date of birth of the user, the marital status of the user, the number of children and/or dependents of the user, and the place of residence of the user. The gender of the user also preferably is received in similar manner (not shown).

The GUI 1200 shown further comprises icons 1220 configured to allow a user to move to a prior or subsequent GUI, and an exit icon 1225 configured to allow the user to exit the GUI 1200.

Preferably, audio content is provided to the user and generally corresponds to text that is displayed in the dialogue box 1210. In alternative embodiments, the audio content may be provided in place of the dialogue box 1210. For example, the virtual human advisor 1205 may comprise a three-dimensional image configured to move in sequence with audio content in order to provide a visual and audible impression to the user of a moving, speaking individual financial advisor.

The virtual human advisor may be chosen from a set of human images based on initial demographic information collected from the user or can be chosen by the user so that the user is presented with a virtual human advisor that he or she is most comfortable sharing confidential information. Thus, a plurality of virtual human advisors preferably are available for use, with one being automatically selected based on information received from the advisee. Further, text and audio used by each virtual human advisor may be the same or different, including the voice and inflection of each virtual human advisor. In other words, under similar circumstances the general subject matter of text on a dialog box and/or audio content may be the same, but the specific text and/or audio content used to communicate the information may be different based on the demographic information that is entered and/or selection of the virtual human advisor by the user. As will be appreciated, relevant information from the user is more readily received through an interactive dialogue using the virtual human advisor.

FIG. 6 illustrates the data flow associated with receiving a user's demographic information as illustrated by the GUI 1200 of FIG. 5. More specifically, FIG. 6 illustrates the data flow within the user demographic information module 116 of the financial planning system 102.

At “Artificial Intelligence State Zero” (AI 0), indicated by reference 300 in FIG. 6, the automated coaching system 114 likely has no information about the user, and the user demographic module 116 receives information about the user through decision tree modules 310, 320, 330, and 340. The decision tree modules in the embodiment shown comprise a module 310 associated with gender, a module 320 associated with age, a module 330 associated with marital status, and a module 340 associated with children 340. In other embodiments, the automated coaching system may collect information about the user though the use of one or more different modules, such as, for example, geographic location, ethnicity, occupation, education level, etc.

Within the gender decision tree module 310, the user is asked whether the user is male 311 or female 312, and the answer and/or resulting data based thereof is recorded in a demographic data sort module 350.

Within the age decision tree 320, a user is asked to input his or her date of birth, and the answer and/or resulting data based thereof is recorded in the demographic data sort module 350. Preferably, the financial planning system 102 selects one of three stages of life 321,322,323, based, at least in part, on the date of birth provided by the user. Alternatively, the user may be asked to select his or her stage of life, and in a variations, fewer or greater number of stages may be used.

Within the marital decision tree 330, a user is asked to select one of three marital status states 331,332,333, and the answer and/or resulting data based thereof is recorded in the demographic data sort module 350. In other embodiments, a few or greater number of marital status states may be used.

Within the children decision tree 340, a user is asked to indicate 341 whether he or she does or does not have children. If the user has children, the user may be asked how many children he user has. As information in the children decision tree module 340 is received, the answer(s) and/or resulting data based thereof is recorded in the demographic data sort module 350.

As will be apparent, the answers received from the user and/or resulting data based on one or more of such answers in accordance with the user demographic module 116 is associated with “Artificial Intelligence State One” (AI 1) 400.

Receiving Current Financial Situation Information

Following the GUI 200 and movement through the data flow scheme in the user demographic information module 116, a user then preferably is presented, for example, with GUI 2000 shown in FIG. 7. GUI 2000 embodies various concepts and methods set forth for financial planning in collecting information regarding the user's current financial situation in financial data collection module 118.

As shown, the GUI 2000 comprises a virtual human advisor 2205 with an associated dialog box 2010 containing text relevant to the process of collecting information from and interacting with a user. The GUI 2000 also includes icons 1220 for moving to previous or following GUI's; an exit icon 2225 for exiting the GUI 2000; and icons 2455 that represent the user's current family situation including a visual representation of each adult and each child/dependent in the family, which is based on information received and recorded by the user demographic information module 116.

The information received and recorded in accordance with the financial data collection module 118 preferably relates to the current financial situation of the user and, specifically, to various current financial assets, debts, and income of the user and user's family.

Such types of financial information are represented, for example, by icon 2481 (credit card), icon 2482 (insurance), icon 2483 (recreational vehicle), icon 2484 (car), icon 2485 (primary home), icon 2487 (student/educational loan), and icon 2488 (retirement/current savings).

In the embodiment shown in FIG. 7, the user interacts with the GUI 2000 and enters financial data as prompted by the virtual human advisor 2205.

For example, when the virtual human advisor 2205 may prompt the user to enter financial information regarding a primary residence that is owned by the user by selecting the appropriate icon 2485 representing a house and supplying requested financial information regarding the house in subsequent GUIs. When completed, a house icon 2460 preferably appears in the vicinity of the family icon 2455, thereby visually indicating to the user that information about the user's current financial situation regarding a primary residence has been received and recorded in the financial planning system 102.

In continuing the example, the virtual human advisor 2205 may then prompt the user regarding any automobiles of the user, and a user answering yes would be prompted to select the car icon 2484 and supply information about the car(s) owned and/or leased by the user in subsequent GUIs. When completed, a car icon then preferably appears in the vicinity of the home icon 2460, visually indicating to the user that information about the user's current financial situation regarding cars has been received and recorded in the financial planning system 102.

In an alternative manner of receiving information from the user regarding the user's current financial situation, the user responds to questions presented to him or her by the financial planning system 102, and additional questions (such as follow-up questions) may then be automatically presented in succession based, at least in part, on the answers to previous questions. Accordingly, the virtual human advisor 2205 may or may not be used for prompting the user to answer more questions.

FIG. 8 illustrates the data flow associated with receiving a user's current financial information as illustrated by the GUI 2000 of FIG. 7.

In particular, a user preferably provides asset, debt, and cash flow information as prompted by the GUI 2000 and related GUIs, and FIG. 8 illustrates the data flow within the financial data collection module 118 of the financial planning system 102, wherein such financial information about the user's assets, debts, and cash flow is received and recorded. Decision trees for assets 410, debts 420, combined assets/debt 430, and cash flow 440 are shown in FIG. 8.

Starting at Artificial Intelligence State One (AI 1) 400, a user is prompted, for example, to supply current financial information via the asset decision tree 410.

Within the asset decision tree 410, a user may be asked in the checking path 411 to provide the amount of money in each checking account of the user as well as the interest rate earned in each account.

Similarly, in each of the savings account path 412, in the savings bonds path 413, or in another type of asset account path 414, a user is asked to provide the amount of money or value of the particular type of assets to which a path pertains.

For example, within the other asset path 414, a securities module 415 is populated through the securities type decision tree 470 if the user indicates that securities are owned by the user. Within the securities type decision tree 470, information is received from the user regarding the type and dollar value of each security within each of the following types of accounts: 401 (k) accounts (401 (k) path 471); IRA accounts (IRA path 472); annuity accounts (annuity path 473); personally held securities at brokerage accounts (securities path 474); insurance accounts, especially those having cash value (insurance path 475); and other securities type investment accounts (other path 476). Depending on the amount of money in various accounts, the asset decision tree by way of the past selection module 450 may continue to request more asset information or may proceed to another decision tree.

The format of information requested within the securities type decision tree 470 may be designed to simplify the information collection process so that the user is not overburdened.

In particular, only specific and necessary information preferably is requested so that the user need not enter too much detail about the securities that he or she owns.

For example, specific values are not necessarily required in accordance with the present invention, and rounding and estimates of the values of the assets (within reason) may be provided by the user while still achieving meaningful financial planning advice.

In another example, if a user has a mutual fund account within a 401 (k) account, then the user may only be asked to supply the total value of the account, the mutual fund ticker symbols of each fund owned by the user, and the percentage of the total value of the 401 (k) invested in the particular fund. Accordingly, a user preferably is not asked to provide the number of shares, the investment goals of the fund, or to identify the type of fund (e.g., large cap, small cap, bond, money market). Useful information related to a security, such as the investment goals of a fund, whether the fund is actively managed, and the maximum yearly contribution limits associated with a fund or tax-deferred savings plan (such as a 401 (k) or 403(b)) may be collected by the financial data module 118 from other resources and not the user, such as from third party web sites accessed through the WAN 104.

Note that this information likely is relevant in determining recommended assets allocations of the user as well as recommending possible savings actions to be taken by the user. For instance, in one embodiment, this information may be used to identify the plan or plans in which the user should increase and/or decrease contributions. For example, if the user is not maximizing his or her contributions to his or her employer's 401 (k) plan, then the user likely will be advised to increase his or her contributions to that plan to the maximum allowed amount.

Within the debt decision tree 420, a user preferably is asked to provide the value of outstanding loans, loan terms, and interest rates for unsecured debt such as, but not limited to, student loans (student loan path 421), credit cards (credit card path 422), and other debts (other debt path 423).

Within the combined asset/debt decision tree 430, a user may be asked to provide the outstanding loan balance and the market value of the underlying assets securing the loan such as, but not limited to, the value and the outstanding loan balance for a home (home path 431), a car (car path 432), or items such as a recreational vehicle (RV path 433).

Within the cash flow decision tree 440, the user may be asked to provide the amount of income (income path 441) from sources such as, but not limited to, salary, interest income, dividends, gifts, Social Security payments, workers' compensation benefits, insurance awards, annuity payments, alimony, or any other source of income which would qualify as taxable income and be reported on IRS Form 1099.

In variations, the individual decision trees of the financial data collection module 118 can be set to request more or less detail regarding a user's assets and/or debts based on factors such as, but not limited to, the size of the assets and/or debts on a category-by-category approach. In other embodiments, additional or fewer decision trees may be included in the financial data collection module 118.

As information in each of the asset decision tree 410, the debt decision tree 420, the combined asset/debt decision tree 430, and the cash flow decision tree 440 is received and recorded, the information is passed to the bi-directional sorting module 450.

As will be apparent, the answers received from the user and/or resulting data based on one or more of such answers in accordance with the financial data collection module 118 is associated with “Artificial Intelligence State Two” (AI 2) 500.

Receiving Currently Intended Future Life Events Information

Following the GUI 2000 and movement through the data flow scheme in the financial data collection module 118, a user then preferably is presented, for example, with GUI 3000 shown in FIG. 9. GUI 3000 embodies various concepts and methods set forth for financial planning in collecting information regarding the user's currently intended future life events in directed goal setting module 120.

As shown, GUI 3000 comprises virtual human advisor 3205 (Sophie, again) with an associated dialog box (not pictured) containing text relevant to the process of collecting and interacting with a user. GUI 3000 further includes icons 3455 that visually indicate the user's family status and number of children or dependents. Similar to the other GUIs discussed above, GUI 3000 also includes icons 3220 for moving to previous or following GUI's, and an exit icon 3225 for exiting the GUI 3000.

In addition, GUI 3000 shows, for example, a visual indication of the results of a first exemplary run of a Monte Carlo simulation (MC1) 501 (FIG. 10). The exemplary simulation is based on a projected retirement date of the user (the husband in this example), which retirement date is calculated from the user's birth date. The projected retirement date is calculated from the user's birth date. The exemplary simulation further is based on a projected percentage of pre-retirement income of the user that will be desired during retirement, e.g., 65%. Arrow 3273 located along timeline 3270 represents a visual indication of the currently projected date of retirement date along timeline 3270. Note that icon 3273 is located along the timeline 3270 at the projected date of retirement for the user, i.e., circa 2035. A probability scale 3280 is set forth, and a probability scroll arrow 3281 calculated during the Monte Carlo simulation 501 indicates the probability that the user will reach the identified financial planning goal (i.e., retirement on the currently projected date at the projected income level) based on the current financial situation of the user as indicated by the current financial situation information received by financial data collection module 118.

Methods for performing a Monte Carlo simulation are well known to the Ordinary Artisan. Furthermore, in the Monte Carlo simulations discussed herein, the Monte Carlo simulation preferably is utilized to identify the optimum asset allocation or portfolio of assets along the “efficient frontier” that provides the required rate of return for enabling the user to achieve the identified financial planning goal based on the user's current financial situation. Methods for determining the “efficient frontier” also are well known to the Ordinary Artisan. The required rate of return is determined based, in part, on the user's information received and on additional information acquired from third-party resources based on the user's information. Methods for determining a future financial obligation based on an identified future life event, and methods for determining a required rate of return to meet future financial obligations, further are within the level of skill of the Ordinary Artisan.

As this exemplary simulation is based on a projected date and level of retirement income, the user may adjust these factors as desired in order to alter or adjust the probability of achieving the goal. For instance, icon 3273 can be selected by the user and moved to an earlier or later time on the timeline 3270. When icon 3273 is moved, a background Monte Carlo simulation 560 (FIG. 10) is run and the probability scroll arrow 3281 may move up or down along the probability scale 3280 to indicate the new calculated probability. Furthermore, as the user interacts with the GUI 3000, the virtual human advisor 3205 may interact with the user to discuss the results of various simulations or to suggest ways to increase the probability of reaching financial goals such as, but not limited to, deferring retirement. Other factors such as, but not limited to, the savings rate of the user, also may be adjusted as discussed below with reference to FIG. 11.

FIG. 10 illustrates the data flow associated with receiving information regarding a user's currently intended future life events using, for example, GUI 3000.

In particular, a user preferably defines that user's currently intended future life events as prompted by the GUI 3000 and related GUIs, and FIG. 10 illustrates the data flow within the directed goal setting module 120 of the financial planning system 102. Of course, other embodiments may comprise a wide variety of different suitable data flows, decision trees, and/or paths within (or independent of) decision trees.

Starting at AI 2 500 and using the information received in arriving at AI2 500, the user may be prompted to define various financial goals in decision trees 510, 520, 530, and 540.

For example, a user is prompted to identify a currently intended primary life event via the primary goals decision tree 510. Within the primary goals decision tree 510, a user preferably is asked in the primary residence path 511 to provide information related to the desire to own a home, or when he or she plans to buy a home, and the price which the user intends to pay for the home. In the retirement path 512, a user preferably is asked when the user would like to retire and the desired level of pre-retirement income that is to be received during retirement.

Within the secondary goals decision tree 520, a user preferably is asked in the child path 521 whether he or she intends on having children in the future and, if so, the desired year for each intended child. In the marriage path 522, a user preferably is asked whether he or she intends on becoming married if he or she is not already married.

Within the tertiary goals decision tree 530, a user preferably is asked in the education path 531 whether he or she intends to pay for a college education or is planning for any other large educational expense(s) and, if so, the desired year. The user also preferably is asked to identify the type of education and, if a college education, then the intended college. In the vacation path 532, a user preferably is asked when he or she plans to take various vacations, if those vacations are periodic, and the amount the user intends to spend on each vacation. In the cash path 533, a user preferably is asked whether he or she would like to have a certain amount of cash on hand and, if so, the amount of cash and the years during which the cash is to be available. In the bequest path 534, a user preferably is asked whether he or she would like to have a certain amount of money available to transfer at the end of his or her expected lifespan, i.e., projected date of death.

Within the fourth order goals decision tree 540, the user preferably is asked in the car path 541 whether he or she plans to purchase a vehicle and, if so, the anticipated purchase date and the purchase price that the user intends to pay for the vehicle. In the RV path 542, a user preferably is asked whether he or she plans to purchase a recreational vehicle (RV) and, if so, the anticipated purchase date and the purchase price that the user intends to pay for the RV. In the second home path 543, a user preferably is asked whether he or she plans to purchase a second home such as a vacation home and, if so, the anticipated purchase date and the purchase price that the user intends to pay for the second home. In the charity path 544, a user preferably is asked whether he or she intends to contribute money to charity and, if so, how much money he or she would like to be able to contribute to charity and the year of each such contribution. In the other goal path 545, additional inquiries are made and information received regarding other currently intended future life events of the user that will result in future financial obligations of the user.

The order in which the user is prompted or asked to identify currently intended future life events may depend upon information previously received from the user including, but not limited to, the age, sex, size of particular assets, marital status, and number of dependents of the user. The order in which questions are asked in the directed goals selection module 120 is determined by the path selection module 550 as information received from the user and recorded in the financial planning system 102.

Referring again to GUI 3000 of FIG. 9, a user preferably may enter a decision tree of the directed goals selection module 120 by selecting an appropriate icon from icons 3450. In order of appearance, the exemplary icons shown in GUI 3000 of FIG. 9 include life events relating, respectively, to a wedding, birth of a child, purchase (or lease) of a car, purchase of a second home, educational expense, and retirement.

As information is received from the user in the directed goals selection module 120, the “Artificial Intelligence State Three” (AIᵢ3) 601 (FIG. 10) is defined or, if previously defined, then redefined. Furthermore, as information is received and recorded in the directed goals selection module 120 and AIᵢ3 601 is defined or redefined, a Monte Carlo state two (MCᵢ2) 602 consequently is defined or redefined based on the received information. The exemplary probability initially calculated in accordance with MC1 501 is visually updated with a new probability in GUI 3000 by the probability percentage visual change module 570. Alternatively, the probability percentage visual change module 570 may update the probability following indication by the user that he or she has provided all the information for the directed goals selection module 120.

For example, starting with the example shown in FIG. 9, upon receiving information regarding an anticipated college education for the user's daughter in education path 531, the GUI accordingly illustrates a revised probability in FIG. 9a which probability takes into account the future financial obligation represented by the anticipated college education. It will be noted that, by factoring in an additional future financial obligation, the probability that the user will meet both of his two financial obligations associated with the identified life events (paying for the college education and retiring) has decreased (arrow 3281 has lowered on the probability scale 3280). It will further be noted that a new icon 3272 is presented representing the additional life event—the college education for the daughter—that now has been factored into the new probability. The anticipated year, i.e., 2017, also is visually represented. Moreover, the anticipated year may be altered by moving icon 3272 along the timeline 3270, which will result in a new probability calculation.

As will be appreciated from the foregoing description, as the user enters life events, the user is able to see the effect of each life event on the calculated probability of the user meeting all of the life events via GUI 3000. Moreover, if a user is curious regarding the possible effect that a change in the information regarding a life event identified in directed goals selection module 120 will have on the percentage probability of reaching all of the user's identified goals, the user may revise the information in any or all of the decision trees 510, 520, 530, 540, and the impact on the probability of attaining the goals, in turn, is displayed in the GUI 3000 and may further be discussed by the virtual human advisor 3205 in GUI 3000.

Once a user is satisfied with the life events that have been identified and information pertaining thereto has been received and recorded in the directed goal selection module 120, a final AIᵢ3 state is defined.

Recommendations for Achieving Higher Probability of Meeting Financial Obligations of the Life Events

Following the GUI 3000 and movement through the data flow scheme in the directed goal selection module 120, a user then preferably is presented, for example, with GUI 4000 shown in FIG. 11. GUI 4000 embodies various concepts and methods set forth for financial planning in adjusting factors in the financial planning customization module 122 that affect the probability that the user will meet the future financial obligations associated with the identified life events.

As shown, GUI 4000 includes virtual human advisor 4205 with an associated dialog box (not pictured) containing text relevant to the process of collecting and interacting with a user. GUI 4000 further includes icons includes icons 4220 for moving to previous or following GUI's, and an exit icon 4225 for exiting the GUI 4000. Similar to GUI 3000, GUI 4000 further includes a visual indication of the results of the Monte Carlo simulation based on MCⱼ2 602 (FIG. 10), which simulation is based on the information recorded and reflected in AIᵢ3 (FIG. 10). In this regard, a probability scroll arrow 4601 indicates the probability, calculated during the Monte Carlo simulation based on MCⱼ2, that the user will achieve the identified life events (i.e., meet the financial obligations associated therewith) based on the current financial situation of the user.

GUI 4000 further includes icons 4401-4404 that represent the data associated with the various life events identified by the user in the directed goals selection module 120 and corresponding check boxes 4400. A check in each respective checkbox indicates that the corresponding future financial obligation for the identified life event has been factored into the calculation of the probability indicated by arrow 4601. Additionally, the user may uncheck one or more checkboxes 4400 thereby permitting the user to exclude these corresponding life events from consideration in the calculation of the probability.

GUI 4000 additionally includes scroll bar arrows 4410, 4420, 4430, 4440, 4450, and 4460 that visually indicate, respectively: the savings rate (percentage of income being saved) 4410 along scale 4411; the retirement contribution (percentage of income being set aside for retirement) 4420 along scale 4421; the intended retirement age 4430 along scale 4431; the level of retirement income (as a percentage of pre-retirement income) 4440 along scale 4441; the rate of income growth comprising, for example, raises (as an annual percentage) 4450 along scale 4451; and the level of charitable contributions (as a percentage of income) 4460 along scale 4461. Furthermore, as discussed below with reference to FIG. 12, each movement of an arrow icon 4410, 4420, 4430, 4440, 4450, and 4460 along a respective scroll bar 4411, 4421, 4431, 4441, 4451, and 4461, and the changing of one or more check boxes 4400, equates to an change in one or more variables of the Monte Carlo simulation and results in a new simulation being run.

In addition to allowing a user to customize the various factors in the financial planning customization module 122 that affect the probability that the user will meet the future financial obligations associated with the identified life events, the user alternatively may adjust the probability itself for a consequent change in one or more of the various factors. In this regard, arrow 4601 preferably is adjustable by the user along scale 4600, and a resulting change in the probability desired by the user may result in the financial planning system 102 adjusting one or more of the arrows 4410, 4420, 4430, 4440, 4450, and 4460 along respective scroll bars 4411, 4421, 4431, 4441, 4451, and 4461 in accordance with predetermined algorithms for such adjustments. Moreover, if the user attempts to set a probability that is not obtainable, then the arrow 4601 preferably reverts back to the last probability indicated along scale 4600.

FIG. 12 illustrates the data flow associated with a user's interaction with the GUI 4000 illustrated in FIG. 11 within a financial planning customization module 122.

Starting at AIᵢ3 601, the financial planning system 102 has received information from the user in the user demographic module 116, the financial data collection module 118, and the directed goal selection module 120 to define state AIᵢ3 601 and, based thereon, to define MCⱼ2 602, the probability calculated therein being displayed in the initial display of GUI 4000.

As discussed above with reference to FIG. 11, the user may adjust the factors or ultimate probability, as desired. Furthermore, in addition thereto, the user may be asked or prompted by the virtual human advisor 4205 to vary, include, or exclude, one or more goals or certain information or factors based on the information of state AIᵢ3 601. The order in which a user may be prompted to vary, include, or exclude one or more goals or certain information is determined by the path selection module 650 and may be based on factors such as, but not limited to, percent savings versus income or age. The algorithms utilized in path selection 650 (as well as path selection 450 and path selection 550) are derived from and based on sound financial advice that is in accordance with advice from professional (real) human advisors who, preferably, are certified financial planners or have similar skills, experience, knowledge, and capabilities.

The financial planning customization module 122 includes several decision trees, including goal variation decision tree 610, lifestyle variation decision tree 630, and probability decision tree 640.

Within the goal variation decision tree 610, a user preferably is asked whether a life event is to be included in or removed from consideration in the calculation of the probability of achieving the life events. In this regard, the user may include via goal check path 611 an identified life event for consideration in the Monte Carlo simulation, or a user may remove via goal uncheck path 612 a life event from consideration in the Monte Carlo simulation.

The user further may be able to vary information received regarding a particular life event or even add a new life event or delete an identified life event from the financial planning system 102 (not shown). For example, the user may be able to repeat the financial information collection module or the directed goal selection module as desired for updating or changing the user's information that is received within the financial planning system 102.

Within the lifestyle variation decision tree 630, a user preferably is asked in the savings percent path 631 whether he or she desires to increase or decrease his or her percentage of savings relative to his or her income and is given the opportunity to do so. In the charity path 632, a user preferably is asked whether he or she desires to increase or decrease the amount of his or her charitable contributions and is given the opportunity to do so. In the contribution path 633, a user preferably is asked whether he or she desires to increase or decrease contributions and is given the opportunity to do so. In the retirement age path 634, a user preferably is asked whether he or she desires postponing or accelerating the date of his or her retirement and is given the opportunity to do so. In the income level path 635, a user preferably is asked whether he or she desires to increase or decrease the anticipated growth in income over the coming years and is given the opportunity to do so. In the retirement income path 637, a user preferably is asked if he or she desires to increase or decrease the percentage of pre-retirement income desired or required during retirement and is given the opportunity to do so.

Within the probability variation decision tree 640, a user preferably is asked in the direct change path 637 whether he or she desires to increase or decrease the probability of achieving the identified life events resulting in changes in the identified life events and/or lifestyle of the user. If the user so desires, then the user preferably is prompted to move the probability scroll arrow 4601 along the probability scale 4600 of FIG. 11 to the desired probability for reaching the user's various financial goals. Such an adjustment results in the “reverse” Monte Carlo simulation so as to define appropriate values for the variables that are necessary and recommended in order to achieve the indicated probability selected by the user.

As a user enters information into the financial planning customization module 122, the “Artificial Intelligence State Four” (AIᵢ4) 701 (FIG. 12) is defined and, if already defined, then redefined; and the corresponding Monte Carlo Simulation state (MCⱼ3) 702 (FIG. 12) further is defined or redefined, accordingly; and the resulting change in this Monte Carlo state is displayed in one or more of the scroll arrows of GUI 4000.

As will be apparent from the foregoing, if a user is dissatisfied with the percent probability of reaching the user's financial goals, or if the user is curious about the impact of a change on the probability of reaching the user's financial goals, or upon suggestion from the human image advisor 4205, the user can elect to redefine information in any or all of the paths of the decision trees 610 and 630, and the impact on the probability of reaching the user's financial goals then is displayed in GUI 4000 and can be discussed by the virtual human advisor 4205. Conversely, the user can set the probability in the probability variation module 640 (preferably by moving the probability scroll arrow 4601 along the probability scale 4600 in GUI 4000) and the Monte Carlo simulation module 660 can run “in reverse” for displaying in GUI 4000 the necessary and recommended settings in the user's goals lifestyle for obtaining the probability desired by the user.

Considering Particular Life Events and Overall Effects on the Financial Plan

Referring now to FIG. 13, an illustration of an interactive financial planning advisor interface displaying a financial situation comprising a preferred result set in accordance with the present invention is shown. The result set comprises a financial plan to which the user may refer in order to work toward achieving the financial goals associated with his or her identified life events. The result set preferably is presented to the user in, for example, GUI 5000, which includes a virtual human advisor 1205 (Sophie again!) and, optionally, an associated a dialogue box (not shown) containing text and/or video or audio content relevant to the result set. The virtual human advisor 1205 preferably walks the user through the results in an explanatory manner and, further, responds to questions that may be presented by the user.

The result set shown in GUI 5000 in particular comprises an indication 5010 of the user's starting assets, an indication 5020 of the user's probable assets at his or her time of retirement, a probability 5030 of meeting all of the user's identified life events (i.e., meeting all of the future financial obligations associated therewith), and a graph 5100. The graph 5100 visually indicates via line 5110 the expected variation in the user's probable net assets over the years and preferably includes indications 5120 of the various user-identified life events scheduled to occur over those years. The graph 5100 further comprises an indication of how a recommended savings rate varies with time, and a plurality of bar chart indications 5140 of the recommended variation in allocations of assets of the user over time. The time period represented in the graph 5120 is between the present time of the user's interaction with the financial planning system 102 (e.g., 2003) and the user's proposed time of retirement in the year (e.g., 2035).

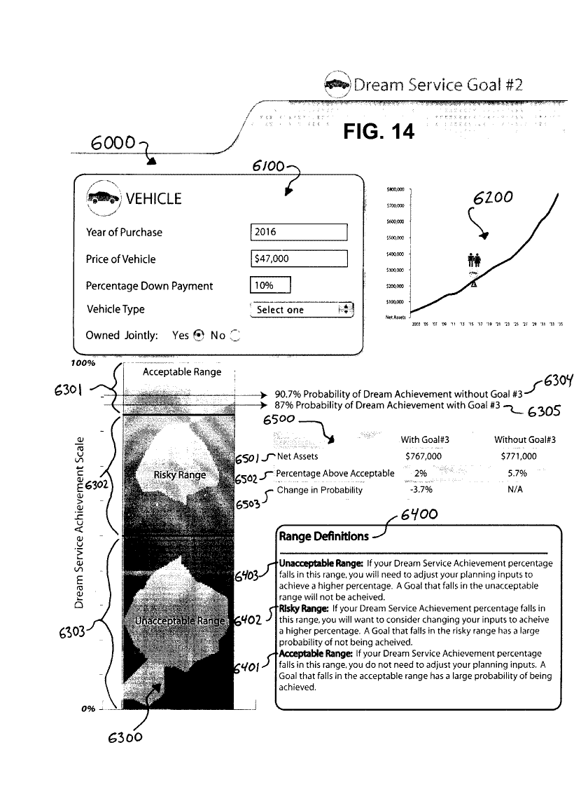

FIGS. 14, 15, 16, and 17 each comprises an illustration of the effects and likelihood of achieving a particular user specified goal. Each further illustrates how including the particular user specified goal thereof has an affect both on the probability of achieving other user specified goals and on the net assets available to a user at retirement.

For example, FIG. 14 includes a GUI 6000 that relates to the life event of purchasing a car in 2016 for $47,000 with a 10% down payment and the effects of this life event. The specific information regarding the life event is illustrated at 6100 in FIG. 14. A graph 6200 includes the value of the user's net assets over time and an indication (icon representing jointly owned car) of when the user intends to purchase the car relative to the overall timeframe.

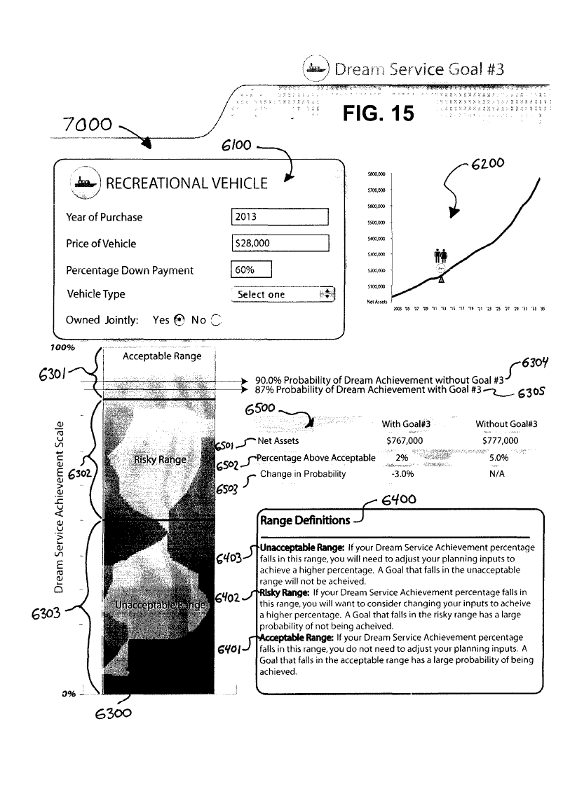

FIG. 15 includes a GUI 7000 that relates to the life event of purchasing a recreational vehicle, such as a boat, in 2013 for $28,000 with a 60% down payment and the effects of this life event. The specific information regarding the life event is illustrated at 6100 in FIG. 15, and a graph 6200 includes the value of the user's net assets over time and an indication (icon representing jointly owned recreational vehicle) of when the user-intended purchase is to occur.

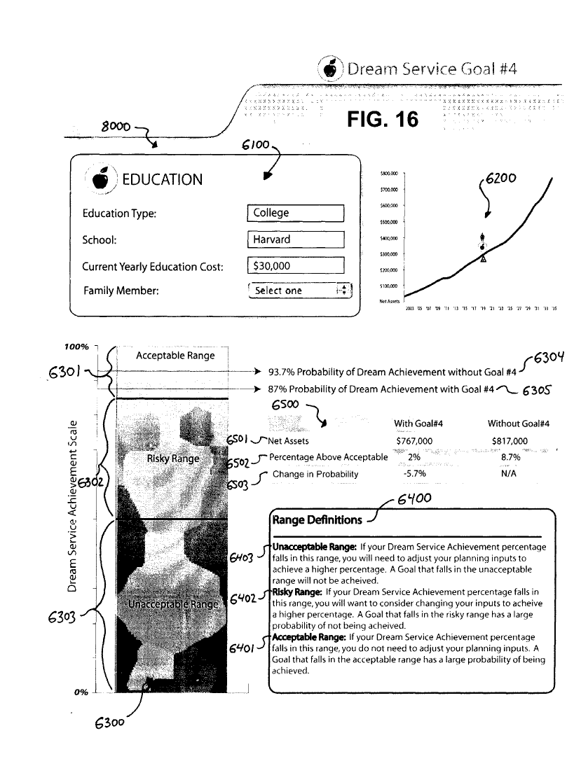

FIG. 16 includes a GUI 8000 that relates to the life event of providing a Harvard education beginning in 2019 for $30,000 and the effects of this life event. The specific information regarding the life event is illustrated at 6100 in FIG. 16, and a graph 6200 includes the value of the user's net assets over time and an indication (icon representing jointly owned recreational vehicle) of when the user-intended outlay of money is to occur.

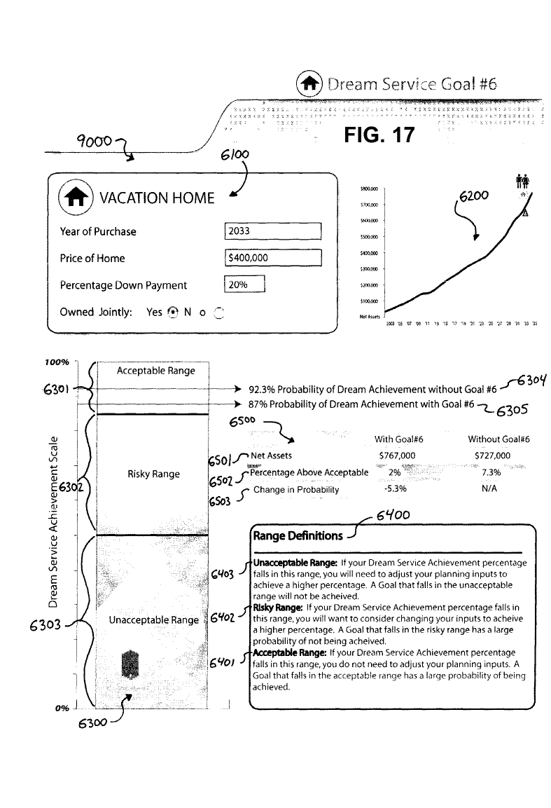

FIG. 17 includes a GUI 9000 that relates to the life event of purchasing a vacation home in 2033 for $400,000 with a 20% down payment and the effects of this life event. The specific information regarding the life event is illustrated at 6100 in FIG. 17, and a graph 6200 includes the value of the user's net assets over time and an indication (icon representing jointly owned vacation home) of when the user-intended purchase is to occur, which is close to retirement.

Each of the GUIs 6000, 7000, 8000, and 9000 also include a probability of goal achievement scale 6300 that includes three distinct areas or ranges of probabilities. In other embodiments, a greater or a fewer number of ranges of probabilities may be used. In the exemplary illustrations of FIGS. 14-17, the “acceptable” range of probability 6301 in the illustrated example is approximately 85% to 100%. The “risky” range of probability 6302 is approximately 50% to 85% and the “unacceptable” range of probability 6303 is approximately 0% to 50%. A list of range definitions 6400 also is included in each of the GUIs for the benefit of the user. The list of range definitions 6400 comprises a list of definitions associated with the ranges shown in the scale 6300. The list of range definitions 6400 may provide a user with an indication of whether or not any factors or goals should be adjusted in order to make his or her goals more or less likely to occur, and/or to end up with a greater or lesser amount of net assets at retirement. The definition associated with the acceptable range 6401 in the embodiment shown suggests that the user need not adjust any planning inputs. The definition associated with the risky range 6402 in the embodiment shown suggests that the user may wish to adjust one or more of his or her inputs to increase the chances of achieving one or more user specified goals. The definition associated with the unacceptable range 6403 in the embodiment shown suggests that the user needs to adjust one or more of his or her inputs in order to make the likelihood of his or her goals coming to fruition more likely.

Returning to FIG. 14, for example, two indications of probabilities are shown along the scale 6300 that relate to the user's chances of achieving the financial goals of the user that differ based on the intended purchase of the $47,000 automobile in 2016. A first probability is shown at 6304 that comprises the probability of achieving all of the user's other specified financial goals (“Dream Achievement”) without purchasing the $47,000 automobile. A second probability is shown at 6305 that comprises the probability of achieving all of the user's other specified financial goals with purchasing the $47,000 automobile. In the embodiment shown, the probability of the user achieving all of his or her other financial goals without the purchase of the $47,000 automobile is greater than the his or her chances with the purchase of the $47,000 automobile (3.7% increased probability).

It should further be noted that both probabilities 6304, 6305 fall within the acceptable range 6301 of the scale 6300. Accordingly, the user may refer to the list of range definitions 6400, and may infer that the interactive financial planning advisor does not suggest that he or she adjust any of his or her life events or lifestyle attributes.

GUI 6000 further comprises a table 6500. The table 6500 readily conveys information showing at 6501 the effect of the particular life event (purchasing the $47,000 automobile in 2016) on the net assets that the user will be likely to have at his or her time of retirement. The table 6500 readily conveys information showing at 6503 the effect of the particular life event on the overall probability of the user achieving all of the life events with the particular life event, and at 6502 the percentage margin above the threshold level of an acceptable probability with and without the particular life event. Similarly, FIGS. 15, 16, and 17 include the same table showing the effects of the respective particular life events thereof.

In a preferred variation of the result sets of FIG. 14-17, the user specifies the action that comprises the life event effect without necessarily having to guess at the future financial costs of such event. For instance, referring to FIG. 14, the user preferably indicates his or her intent to purchase a luxury sports utility vehicle (SUV) in the year 2016, and the financial planning system 102 preferably projects the future financial obligation associated therewith based on historical information and industry data. The use may even specify a similar make and model of the car, such as a Mercedes M class vehicle or similar. This information is sufficient to provide meaningful results without placing the burden on the user to project or guess what the price of the vehicle will be in the intended year of purchase. Thus, this preferred alternative is believed to facilitate interaction with the financial planning system 102.

Recommending Asset Allocations Based on Monte Carlo Simulations and Efficient Frontier Portfolio Model

FIGS. 18 and 19 each illustrates recommend asset allocations to the user based on the information received from the user and, in particular, based on the Monte Carlo simulation performed in accordance with this information.

In this regard, pie chart indications of proposed asset allocations 10010, 10020, 10030, 10040, and 10050 are shown in GUI 10000. Each of the proposed asset allocations is associated with a different level of risk, potential for growth, and time period in the user's future. For example, a high growth asset allocation pie chart 10010 is associated with a time period 10001 in the immediate future (2003-2009), a high potential for growth, and a high amount of risk. Similarly, a medium growth asset allocation pie chart 10020 is associated with a time period 10001 beyond the immediate future (2009-2015), a medium potential for growth, and a medium amount of risk. A growth asset allocation pie chart 10030 is associated with a time period 10001 in the future (2015-2023), a low potential for growth, and a low amount of risk.

Referring to FIG. 19, an income asset allocation pie chart 10040 is shown. The income asset allocation pie chart 10040 is associated with a time period 10001 in the distant future (2023-2031), a very low potential for growth, and a very low amount of risk. A retirement asset allocation pie chart 10050 is associated with a time period 10001 during the user's transition into retirement (2031-2035), an extremely low potential for growth, and an extremely low amount of risk.

In these examples, it will be apparent that each asset allocation shown preferably is the asset allocation recommended in accordance with the appropriate Monte Carlo simulation for achieving the user's intended future life events during the period of time based on the efficient frontier portfolio model. Such a technique does not rely upon an investor's risk tolerance and, by definition, the optimum portfolio selected on the efficient frontier represents the lowest risk asset allocation to achieve the rate of return that is required. Accordingly, in these examples it just so happens that the growth and perceived risk combinations associated with each asset allocation become more conservative as between consecutive periods of time. These examples further show that the overall period of time of the user may be divided and treated in distinct segments in accordance with the financial planning system of the present invention.

Referring again to FIG. 18, suggested lists of savings rates 10002 are shown for various time periods within the time periods 10001. Listings of the percentages shown in the plurality of pie chart indications of proposed asset allocations 10000 are also shown 10003. Explanations 10004 of the charts 10000 may be provided. In the exemplary illustrations, the explanations 10004 comprise random assortments of letters that are intended to represent information (such as text, video or audio content) that is provided to the user to help the user to decipher the asset allocations being recommended by the interactive financial planning system 102. FIG. 18 further comprises lists of potential financial products and services providers 10005 from whom the user may be able to purchase financial goods and services. In some embodiments, the list of financial products and services providers may vary based on the type of asset allocations that are recommended.

FIGS. 18 and 19 further comprise a bar chart indication of proposed asset allocations 5140 over the same time period as displayed by the pie charts 10010, 10020, 10030, 10040, and 10050. The bar chart indication of proposed asset allocations 5140 shown provides a suggested asset allocation and savings rate for every two-year period from 2003 to 2035. The bar chart indication of proposed asset allocations 5140 may provide a user with an alternative indication of actions and/or suggestions that he or she may take as suggested by the interactive financial planning system 102.

Coaching System Having Artificial Intelligence for Facilitating User Interaction

The interactive financial planning system 102 optionally, but preferably, includes an automated coaching system 114 (FIG. 1) that dispenses natural language, textual coaching to the user (advisee) at the user terminal 110. In this regard, each of the GUI's described with reference to FIGS. 5, 7, 9, 9a, 11, 13, 14, 15, 16, 17, 18, and 18 preferably is associated with the coaching system 114 such that the amount of prompting or dialogue from the human advisor image may be tailored to the user.

For example, the information and/or interaction provided by Sophie, the virtual human advisor may be based, at least in part, on a user's comfort with the GUIs. In this regard, if the artificial intelligence of the coaching module 114 detects that a user is quickly entering data, the virtual human advisor may reduce or cease interacting with the user. Conversely, if a user is slow to enter information, a greater level of interaction from the virtual human advisor may be implemented. Furthermore, information conveyed by the virtual human advisor to the user may be based, at least in part, on information previously received from the user.

In one embodiment, the amount of interaction between the automatic coaching system 114 and a user of the system may vary based, at least in part, on a level of self-direction of the user. For example, if the user rapidly provides answers and other information with adequate amounts of data, the automatic coaching system 114 may determine that the user is self-directed and may refrain from or reduce a level of interaction with the user.

Conversely, if the user takes longer periods of time to provide information, and/or provides the system with inadequate amounts or a complete lack of information and/or answers with seemingly impossible values or units, the automatic coaching system 114 may determine that the user is not self-directed, and may increase the level of interaction with the user, and/or may change the type or style of interaction with the user, such as by providing audio content at a faster or slower pace, a louder or quieter volume level, by providing text in a larger or smaller font size, by providing a different font style, and/or by providing text in a different font and/or background color to increase or decrease its visibility. In one embodiment, the automatic coaching system 114 may not be used at all, such as in the case of a repeat or advanced user. In another embodiment, the automatic coaching system 114 may be continuously present regardless of the rate or amounts of information provided by the user.

Each user's experience thus may be different based on the user's interaction with the financial planning system 102 and based on the information that is received by the financial planning system 102 from the user.

Continuing in this regard, the demographic data sort module 350 and/or the coaching system may be configured to alter the ordering, arrangement, content, rate, and/or wording of questions, requests for information, output of information, etc. during the interview process. In one such embodiment, the demographic data sort module 350 may adjust the interview process based, at least in part, on data associated with a particular user. For example, the order in which various questions associated with each decision tree are presented to the user can be modified based on various factors such as, but not limited to, information that would have the greatest impact to the user's financial future and well being, and information that a person of a particular sex may be predisposed to be considering.

This description extends equally to each of the financial data collection sort module 450, the directed goal selection sort module 550, and the financial plan customization sort module 650. Moreover, the sort modules preferably determine the priority in which additional decision tree questions and path selections are presented to the user and/or the sequence of the presentation of the questions presented by the virtual human advisor. The sorting of questions, requests for input, type of interaction, amount of interaction, and other actions to taken by the virtual advisor interface may be based, at least in part, on a user's demographics, financial goals, and/or current situation information. Such information may be used to provide a more educated and useful virtual human advisor, and/or to provide a more logical order, sequence, and/or manner in which the virtual human advisor interacts with the user.

The information received from the user varies as the user progresses through the various modules and, accordingly, the degree of variation in the user experience increase as the further time is spent interfacing with the system. Indeed, starting at AI 0 300 (FIG. 6), little to no information has been received about the user. However, the user demographic module 116 receives information about the user through decision tree modules 310, 320, 330, and 340 and, based thereon, the user experience may begin to vary. By the time the user engages the financial data collection module, the automatic coaching system 114 has a significant amount of information about the user at AI 1 400 (FIG. 8). Based on this information, the financial data collection module 118 and or the coaching module 114 may prioritize to large degree the order in which information about the user's current financial information is collected based on factors such as, but not limited to, the importance to the user's financial plan. Upon collection of the financial information through the decision trees in the financial data collection module, the information provided by the user defines AI2 500 (FIG. 10). Similarly, upon the additional collection of the information through the decision trees in the directed goal selection module, the information provided by the user defines AI3 601 (FIG. 12).

Alternative Preferred Interfaces

Alternative interactive financial planning advisor interfaces in accordance with other preferred embodiments of the present invention are illustrated in FIGS. 20-30 and 32-33.

In particular, FIG. 20 illustrates an alternative interactive financial planning advisor interface for receiving information regarding demographic information in accordance with a preferred embodiment of the present invention.

FIGS. 21-23 collectively illustrate alternative interactive financial planning advisor interfaces for receiving information regarding current financial situations in accordance with a preferred embodiment of the present invention. Specifically, FIG. 21 illustrates an interactive financial planning advisor interface for receiving information regarding owned assets. FIG. 22 illustrates an interactive financial planning advisor interface for receiving information regarding investments. FIG. 23 illustrates an interactive financial planning advisor interface for receiving information regarding debts.

FIG. 24 illustrates an interactive financial planning advisor interface for receiving specific information regarding a primary residence that is owned, which interface is presented following the interface of FIG. 21 when the “Home” hyperlink is selected.

FIG. 25 illustrates an interactive financial planning advisor interface for receiving specific information regarding a retirement account, which interface is presented following the interface of FIG. 22 when the “401 K” hyperlink is selected.

FIG. 26 illustrates an interactive financial planning advisor interface for receiving specific information regarding a student loan, which interface is presented following the interface of FIG. 23 when the “Student Loans” hyperlink is selected.

FIG. 27 illustrates an alternative interactive financial planning advisor interface for receiving information regarding currently intended future life events in accordance with a preferred embodiment of the present invention.

FIG. 28 illustrates an interactive financial planning advisor interface for receiving specific information regarding a currently intended future purchase of a primary residence, which interface is presented following the interface of FIG. 27 when the hyperlinked icon for a house is selected.

FIG. 29 illustrates an alternative interactive financial planning advisor interface for displaying a probability of meeting current goals and for tailoring factors influencing such probability in accordance with a preferred embodiment of the present invention.

FIG. 30 illustrates an alternative interactive financial planning advisor interface displaying a financial situation comprising a result set—or “Goal Blueprint™” results—in accordance with a preferred embodiment of the present invention. The Goal Blueprint results include the currently intended future financial goals as specified by the user, a recommended asset reallocation, and a probability of meeting the specified currently intended future financial goals.

FIG. 32 illustrates an alternative interactive financial planning advisor interface displaying a financial situation comprising a plurality of current asset allocations among different investment types (e.g., large cap, small cap, bonds, and cash) and recommended reallocations among the different investment types in accordance with a preferred embodiment of the present invention.

FIG. 33 illustrates another alternative interactive financial planning advisor interface displaying a financial situation comprising a plurality of current asset allocations among different investment types (e.g., large cap, small cap, bonds, and cash) and recommended reallocations among the different investment types in accordance with a preferred embodiment of the present invention.

In addition to these alternative interfaces of FIGS. 21-30 and 32-33, a “Goal Achievement Probability Graph” as shown in FIG. 31 preferably is available for display to the user. The graph visually represents the statistical output of a financial model simulation that is used to generate a probability like the probability represented in the interface of FIG. 30.

A personal financial snapshot associated with the Goal Blueprint™ results also preferably is available for display to the user as shown in FIG. 34. Such a snapshot represents a current balance sheet of the user.

A preferred home page on the Internet for offering services is illustrated in FIG. 35. The services preferably are offered via the Internet.

Alternative Interactive Financial Advisor Interfaces

Scope of the Present Invention

The foregoing detailed description of preferred embodiments is not intended to limit the breadth of protection afforded by the claims on any granted patent. Various alterations and other embodiments, including all of the various combinations of features and aspects of the present invention above, are disclosed and encompassed within the scope of the present invention together with all equivalents thereof.

In this regard, while the wide area network of the interactive financial information system of FIG. 1 has been described as comprising the Internet and the TCP/IP protocol, the present invention is not limited to the Internet and the TCP/IP protocol. The present invention can be implemented using any suitable protocol and many other networking systems, comprising wireless networks, the Network File Service (NFS) protocol used by Sun Microsystems or a Novel network based on the UDP/IPX protocol.

Additionally, while the present invention as been described with regard to a wide area network, such as the Internet, it will be appreciated that the present invention can be implemented on a stand alone desktop or laptop computer. For example, the program implementing the present invention may reside on a hard drive or optical storage medium, and the program may be distributed or sold in combination with other financial software such as Quicken™ or Money™.

It will be further appreciated that the present invention also preferably provides an a la carte type system, whereby the user may input only desired pieces of financial information and certain desired life events for analysis and advice based only thereon.

What is claimed is:

1. A method of providing financial planning advice to an advisee via a computer, comprising the steps of:
(a) receiving current information of the advisee, the current information comprising,
(i) data indicative of a current financial situation of the advisee including assets of the advisee, and
(ii) data indicative of a currently intended future life event of the advisee;
(b) determining a future financial obligation of the advisee that is representative of the intended future life event of the advisee;
(c) determining a rate of return on investment that is required in order for the advisee to meet the future financial obligation based on the advisee's current financial situation; and
(d) providing to the advisee a recommended asset allocation and an indication of the probability that the future financial obligation will be met based on the advisee's current financial situation and the recommended asset allocation.

2. The method of claim 1, wherein the assets comprise investment assets of the advisee.

3. The method of claim 1, wherein the investment assets comprise indirect and direct investments in stocks and bonds.

4. The method of claim 1, wherein said step of determining the future financial obligation of the advisee comprises the step of calculating a numeric value representative of the future financial obligation.

5. The method of claim 1, wherein said step of determining the required rate of return on investment comprises the step of calculating a numeric value.

6. The method of claim 1, wherein the data indicative of the current financial situation information comprises data indicative of the current balance sheet and cash flow of the advisee.

7. The method of claim 1, wherein the financial situation information comprises data indicative of the current income, current assets, current debts, current savings, and current spending of the advisee.

8. The method of claim 1, further comprising storing information regarding current financial situation and information regarding intended future life event in a computer-readable medium.

9. The method of claim 1, wherein the method is performed in a computer system.

10. The method of claim 1, wherein the data indicative of the information regarding the current financial situation and the data indicative of the information regarding the intended future life event is electronically received from the advisee through a web-based interface.

11. The method of claim 1, wherein the method is performed at one or more servers remotely located to the advisee, and wherein the advisee communicates with the one or more servers via the Internet.

12. The method of claim 1, wherein the financial obligation representative of the intended future life event is calculated based on current costs associated with the life event, and wherein the current costs associated with the life event are acquired from other than the advisee.

13. The method of claim 1, further comprising the step of determining an asset allocation based on the financial information of the advisee and based on the required rate of return on investment determined in said step (d), and wherein said determination is not based upon a risk tolerance of the advisee.

14. The method of claim 13, wherein the step of determining the asset allocation includes the step of performing a Monte Carlo simulation/analysis/calculation in order to determine an asset allocation having the greatest probability of obtaining the required rate of return on investment with the lowest risk in accordance with the efficient frontier portfolio model.

15. The method of claim 1, wherein the current future life event comprises one of the group of: retiring; buying a car; providing for an education; having a child; getting married; and buying a house.

16. A computer-readable medium containing computer-executable instructions for performing the method of claim 1.

17. A method of providing financial planning advice to an advisee via a computer, comprising the steps of:
(a) receiving current information of the advisee, the current information comprising,
(i) data indicative of demographic information of the advisee,
(ii) data indicative of a current financial situation of the advisee including assets of the advisee, and
(iii) data indicative of currently intended future life events of the advisee, including, for each intended future life event, a respective projected year of the intended future life event;
(b) determining, for each intended future life event, a future financial obligation of the advisee that is representative of the intended future life event of the advisee;
(c) determining an overall rate of return on investment that is required in order for the advisee to meet each of the future financial obligations in each respective projective year based on the advisee's current financial situation; and
(d) providing to the advisee a recommended asset allocation and an indication of the probability that the future financial obligations will be met based on the advisee's current financial situation and the recommended asset allocation.

18. The method of claim 17, wherein the demographic information comprises data indicative of the age, gender, and marital status of the advisee.

19. The method of claim 17, further comprising receiving updated current information for data indicative of at least one of demographic information of the advisee, current financial situation of the advisee, and currently intended future life events, and repeating said steps (b), (c), and (d) based in part on said updated current information of the advisee.

20. The method of claim 17, further comprising providing to the advisee information showing the effect on the probability of said step (d) of a particular one of the life events.

21. The method of claim 17, wherein said step (a) comprises assisting the advisee through a virtual human advisor.

22. The method of claim 21, wherein the virtual human advisor provides assistance to the advisee,
(i) by directing the advisee during the method,
(ii) by providing visual and audible confirmations to the advisee, and/or
(iii) by providing information about the recommended asset allocation and the indication of the probability that the future financial obligations will be met as provided in said step (d).
